(19) United States
(12) Patent Application Publication
(10) Pub. No.: US 2026/0119998 A1
(43) Pub. Date: Apr. 30, 2026

(54) Multiagent Output Prediction for Offline Agent Modeling

(71) Applicant: DeepMind Technologies Limited, London (GB)

(72) Inventors: Florian Nils Hartmann, Zurich (CH); Victor Carbune, Zurich (CH)

(21) Appl. No.: 18/926,828

(22) Filed: Oct. 25, 2024

(51) Int. Cl. G06N 20/20; G06F 9/54

(52) U.S. Cl. CPC G06N 20/20; G06F 9/541

(57) ABSTRACT

Systems and methods are provided. An example method can include obtaining, by a computing system comprising one or more computing devices, first data indicative of one or more outputs of one or more second machine-learned models. The example method can include providing, by the computing system to a first machine-learned model, the first data and a first input context. The example method can include generating, by the computing system using the first machine-learned model, one or more predicted outputs of the one or more second machine-learned models based at least in part on the first input context. The example method can include selecting, by the first machine-learned model based at least in part on the one or more predicted outputs, one or more selected actions from an action space. The example method can include causing, by the computing system, the one or more selected actions to be performed.

### FIELD

The present disclosure relates generally to machine learning processes and machine-learned devices and systems. More particularly, the present disclosure relates to systems and methods for using a first machine-learned agent to model a thought process of a second machine-learned agent.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Example aspects of the present disclosure provide an example method. In some implementations, the example method can include obtaining, by a computing system comprising one or more computing devices, first data indicative of one or more outputs of one or more second machine-learned models. The example method can include providing, by the computing system to a first machine-learned model, the first data indicative of the one or more outputs of the one or more second machine-learned models. The example method can include providing, by the computing system to the first machine-learned model, a first input context. The example method can include generating, by the computing system using the first machine-learned model, one or more predicted outputs of the one or more second machine-learned models based at least in part on the first input context. The example method can include selecting, by the first machine-learned model based at least in part on the one or more predicted outputs, one or more selected actions from an action space. The example method can include causing, by the computing system, the one or more selected actions to be performed.

In the example method, causing the one or more selected actions to be performed can include mapping, by the computing system, an action selection output of the first machine-learned model to a corresponding application programming interface (API) call. In the example method, causing the one or more selected actions to be performed can include calling, by the computing system, a first API according to the corresponding API call.

In the example method, providing the first data can include including the first data in the first input context.

In the example method, the first data can be parameter update data. In the example method, obtaining the parameter update data can include obtaining, by the computing system, training data indicative of one or more interactions of the one or more second machine-learned models. In the example method, the training data can include a plurality of input-output pairs. In the example method, each input-output pair can include a second input context provided to the one or more second machine-learned models during the one or more interactions and a corresponding second-model output generated by the one or more second machine-learned models during the one or more interactions. In the example method, obtaining the parameter update data can include providing, by the computing system to the first machine-learned model, one or more second input contexts of the plurality of input-output pairs. In the example method, obtaining the parameter update data can include receiving, by the computing system from the first machine-learned model, one or more training outputs based on the one or more second input contexts. In the example method, obtaining the parameter update data can include determining, by the computing system based on a loss function comparing the one or more training outputs to one or more corresponding second-model outputs, the parameter update data. In the example method, providing the parameter update data can include updating, by the computing system, one or more parameters of the first machine-learned model according to the parameter update data.

In the example method, the first machine-learned model can include one or more adapter layers. In the example method, updating the one or more parameters can include updating the one or more adapter layers.

In the example method, the computing system can include a plurality of adapters associated with the first machine-learned model. In the example method, each adapter of the plurality of adapters can include one or more adapter layers for predicting outputs of a corresponding second or third machine-learned model. The example method can include selecting, by the computing system from the plurality of adapters, a first adapter associated with the one or more second machine-learned models. The example method can include including, by the computing system, the first adapter in the first machine-learned model. In the example method, the one or more predicted outputs can be generated using the first adapter.

In the example method, the first data can include one or more first delimiters identifying one or more authors of the one or more outputs. In the example method, the first input context can include at least one second delimiter identifying at least one second machine-learned model of the one or more second machine-learned models as an author of the one or more predicted outputs.

The example method can include receiving, by the computing system from the first machine-learned model, one or more confidence values associated with the one or more predicted outputs. The example method can include determining, by the computing system based at least in part on the one or more confidence values, whether to generate, using the one or more second machine-learned models, one or more true outputs based on the first input context.

The example method can include obtaining, by the computing system, second data indicative of at least one of: an availability of the one or more second machine-learned models; a cost of using the one or more second machine-learned models; and one or more data access permissions associated with the first input context and the one or more second machine-learned models. The example method can include determining, by the computing system based at least in part on the second data, whether to generate, using the one or more second machine-learned models, one or more true outputs based on the first input context.

In the example method, the one or more second machine-learned models can include a plurality of second machine-learned models. The example method can include selecting, by the computing system from the plurality of second machine-learned models, a selected machine-learned model to generate the one or more true outputs. The example method can include generating, by the computing system using the selected machine-learned model, the one or more true outputs.

In the example method, selecting can be based at least in part on one or more of: one or more respective amounts of interaction data available for one or more respective second machine-learned models of the plurality of second machine-learned models; and success level data indicative of one or more respective levels of success associated with one or more respective second machine-learned models of the plurality of second machine-learned models.

In the example method, the success level data can include task-specific success level data for a plurality of task categories.

In the example method, the first machine-learned model can have a number of parameters that is smaller than a number of parameters of at least one second machine-learned model of the one or more second machine-learned models. The example method can include providing, by the computing system to the at least one second machine-learned model, data indicative of the one or more predicted outputs. The example method can include receiving, by the computing system from the at least one second machine-learned model, one or more true outputs generated based at least in part on the one or more predicted outputs.

In the example method, the one or more predicted outputs can include a plurality of tokens. The example method can include evaluating, in parallel, by a plurality of processors of the computing system using the at least one second machine-learned model, the plurality of tokens to generate a plurality of token probabilities. The example method can include editing, by the computing system based on the plurality of token probabilities, the one or more predicted outputs to generate the one or more true outputs.

In the example method, generating the one or more predicted outputs can include generating, by the first machine-learned model based at least in part on the first input context, a plurality of draft tokens. In the example method, generating the one or more predicted outputs can include evaluating, by the first machine-learned model, the plurality of draft tokens to generate a plurality of token probabilities. In the example method each token probability can be indicative of a respective probability that the at least one second machine-learned model would output a respective draft token of the plurality of draft tokens. In the example method, generating the one or more predicted outputs can include editing, by the computing system based on the plurality of token probabilities, the plurality of draft tokens to generate the one or more predicted outputs.

In the example method, obtaining the first data can include retrieving, by the computing system based at least in part on the first input context or a second input context, the first data.

The example method can include generating, by the computing system using the first machine-learned model, a first output based at least in part on the first input context. In the example method, the one or more predicted outputs can be generated based at least in part on the first output.

The example method can include providing, by the computing system to the first machine-learned model, data indicative of one or more results of the one or more selected actions. The example method can include receiving, by the computing system from the first machine-learned model, an output based on the data indicative of the one or more results.

Example aspects of the present disclosure provide an example computing system that includes one or more processors and one or more example non-transitory computer-readable media storing instructions that are executable by one or more processors to cause a computing system to perform example operations. In some implementations, the example operations can include obtaining first data indicative of one or more outputs of one or more second machine-learned models. The example operations can include providing, to a first machine-learned model, the first data indicative of the one or more outputs of the one or more second machine-learned models. The example operations can include providing, to the first machine-learned model, a first input context. The example operations can include generating, using the first machine-learned model, one or more predicted outputs of the one or more second machine-learned models based at least in part on the first input context. The example operations can include selecting, by the first machine-learned model based at least in part on the one or more predicted outputs, one or more selected actions from an action space. The example operations can include causing the one or more selected actions to be performed.

Example aspects of the present disclosure provide one or more example non-transitory computer-readable media storing instructions that are executable by one or more processors to cause a computing system to perform example operations. In some implementations, the example operations can include obtaining first data indicative of one or more outputs of one or more second machine-learned models. The example operations can include providing, to a first machine-learned model, the first data indicative of the one or more outputs of the one or more second machine-learned models. The example operations can include providing, to the first machine-learned model, a first input context. The example operations can include generating, using the first machine-learned model, one or more predicted outputs of the one or more second machine-learned models based at least in part on the first input context. The example operations can include selecting, by the first machine-learned model based at least in part on the one or more predicted outputs, one or more selected actions from an action space. The example operations can include causing the one or more selected actions to be performed.

### BRIEF DESCRIPTION OF THE DRAWINGS

FIG. 1 is a block diagram of an example system for agentic action with a first machine-learned agent based at least in part on predicted outputs associated with a second machine-learned agent according to example implementations of some aspects of the present disclosure;

FIG. 2A is a block diagram of interactive agentic action in a multi-agent environment according to example implementations of some aspects of the present disclosure;

FIG. 2B is a block diagram of an example system for single-agent action based at least in part on interaction data from a multi-agent environment according to example implementations of some aspects of the present disclosure;

FIG. 3 is a block diagram of an example system for adaptively selecting between single-agent action and interactive multi-agent action in a multi-agent environment according to example implementations of some aspects of the present disclosure;

FIG. 4 is a block diagram of an example system for adaptively selecting between a plurality of co-agents in a multi-agent environment according to example implementations of some aspects of the present disclosure;

FIG. 5 is a block diagram of an example system for collecting interaction data in a multi-agent environment according to example implementations of some aspects of the present disclosure;

FIG. 6A is a block diagram of an example system for fine-tuning a machine-learned agent according to example implementations of some aspects of the present disclosure;

FIG. 6B is a block diagram of an example system for storing fine-tuned parameters of a fine-tuned machine-learned agent according to example implementations of some aspects of the present disclosure;

FIG. 7 is a flow chart diagram of an example method for agent emulation in a multi-agent environment agent according to example implementations of some aspects of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

Generally, the present disclosure is directed to a lightweight form of agent emulation or output prediction in a multi-agent environment, wherein a first machine-learned agent can use interaction data associated with one or more second machine-learned agents to emulate or predict the outputs of the second machine-learned agents. An agent can be or include, for example, one or more machine-learned models (e.g., sequence processing models) configured to use or interact with other tools (e.g., other agents, other machine-learned models, software tools, interfaces such as application programming interfaces (APIs), etc.) to perform tasks. In some instances, the first machine-learned agent can receive (e.g., from a user) an input, such as an input describing a task to be performed or goal to be achieved. Based on the input, the first machine-learned agent can generate one or more first outputs, such as a task analysis, action plan, or other data. Additionally or alternatively, the first machine-learned agent can emulate a second machine-learned agent, generating one or more predicted outputs that the first machine-learned agent would expect the second machine-learned agent to generate, such as a predicted action plan, a predicted adjustment to a first action plan described in the first outputs, or other predicted outputs. In some instances, the first machine-learned agent can select (e.g., based on the input, first outputs, and/or predicted outputs) one or more actions to perform, and a computing system can perform the selected actions (e.g., using one or more API tools, etc.). In some instances, a result of the selected actions can be provided to a user as output or provided to the first machine-learned agent for further action.

In some instances, the predicted output(s) can be generated based on data indicative of past interactions of a single second agent or a plurality of second agents. For example, in some instances, agents can be grouped by purpose (e.g., coding agents, etc.), input type (e.g., text, multimodal, etc.), size (e.g., number of parameters, etc.), or other grouping (e.g., agent identifier number, etc.), and past interaction data from a plurality of agents belonging to a particular group can be provided to the first agent, which can generate a predicted output based on the interaction data. Similarly, in some instances, interaction data of one or more agents can be filtered by task type (e.g., coding, etc.), input type, or other grouping. As a non-limiting illustrative example, interaction data associated with a “coding agent” group may include first interaction data from one or more special-purpose coding-only agents and second interaction data from one or more multi-purpose agents capable of coding. Continuing the example, interaction data from the multi-purpose agents can be filtered by task type, such that only coding interaction data from the multi-purpose agents is included in interaction data associated with the “coding agent” group.

In some instances, interaction data associated with the second machine-learned agent(s) can be provided to the first machine-learned agent as input context, or can be provided as part of a fine-tuning training process. For example, in some instances, when a total amount of interaction data collected for a particular second agent or group of agents is small, a computing system may provide all of the collected interaction data to the first agent as input context, and the first agent can generate one or more predicted outputs of the second agent(s) based on the input context. As another example, if the total amount of interaction data collected is too large for a context window of the first agent, a computing system can retrieve a subset of the collected data and provide the subset to the first agent as input context. For example, after receiving (e.g., from a user) a first input (e.g., describing a task to be performed), a computing system can retrieve (e.g., from a vector database, etc.) interaction data associated with the first input, such as interaction data having a machine-learned semantic embedding that is similar to an embedding of the first input according to a similarity metric (e.g., cosine distance, Euclidean distance, etc.). Interaction data can include, for example, data collected by a computing device operating the first agent or by another computing system, such as one or more logging servers collecting data associated with a plurality of multi-agent interactions in a distributed multi-agent environment.

If a total amount of interaction data collected for one or more second machine-learned agents is large, the first machine-learned agent can be trained on the interaction data according to a fine-tuning process. For example, in some instances, adapter-based fine-tuning can be used. For example, the first machine-learned agent can start with a plurality of existing machine-learned model layers, and one or more adapter layers can be added (e.g., between existing layers). Adapter-based fine-tuning can include, for example, providing an input to the first agent; generating, by the first agent using the existing layers and the adapter layers, a training output; determining, based on a comparison between the training output and an expected output, a loss value associated with the training output; and updating the adapter layer(s) based on the loss value (e.g., without modifying the existing layers of the first agent).

In some instances, a plurality of adapters can be trained on a plurality of distinct training datasets, such as datasets associated with particular agents or groups of agents, particular task types or input types, or other grouping. In this manner, for instance, a first agent can be trained to imitate a plurality of different second agents, with reduced memory footprint for storing updated model parameters compared to some alternative implementations.

In some instances, a single fine-tuned model can be fine-tuned using interaction data from a plurality of second agents or groups of agents. For example, in some instances, a first agent can be configured to generate a predicted output associated with a second agent when prompted with an agent identification input indicative of a second agent. For example, in some instances, the interaction data can include data comprising one or more delimiters indicating which agent or other tool produced which output (e.g., “User: How many apples are in this image? Agent 1: Call(Agent 2); Agent 2: I have analyzed the image and I counted three apples;” etc.). The first agent can be fine-tuned using data from a plurality of agents, such that the first agent can generate a predicted output associated with a second agent or group of agents when prompted with a delimiter indicative of the second agent or group of agents (e.g., “Agent 2:”, “[Coding Agent]”, “<Gemini family>”, “[Large agents 500B+]”, “Multimodal audio+text agent:”, etc.).

In some instances, an agent can be configured to use tools or perform tasks using various prompting techniques, such as chain-of-thought prompting (e.g., thought-observation-action prompting, etc.), least-to-most prompting, self-critique, or the like. For example, in some instances, an agent can be prompted with a plurality of example task inputs, along with a plurality of example thought processes for performing the respective tasks. In some instances, each example thought process can include a plurality of delimiters configured to mark each part of the example thought process (e.g., “[Thought],” “[Act],” “[Observe]”; “input:”, “tool choice:”, “tool instruction:”; “1” “2” “3”; etc.). An example thought process can include, for example, one or more planning components; one or more action components; one or more action result components; and one or more output components. An action component can include, for example, an instruction to use a tool (e.g., second agent, API tool, etc.). An action result can include, for example, an agent-readable output of the tool.

In some instances, a first agent can be a lightweight agent having a reduced computational cost (e.g., reduced parameter count, reduced memory footprint, reduced processor usage, reduced electricity cost, reduced latency, etc.) compared to one or more second agents. For example, in some instances, a first agent can include a lightweight agent configured to be run on a low-power client device, such as a mobile phone. For example, the first agent can have a memory footprint small enough to be stored in memory of a client device (e.g., mobile phone) or a number of parameters small enough to perform inference on a client device (e.g., within a latency target, etc.). Additionally, in some instances, a first agent can have one or more data access permissions that may be different from data access permissions of a second agent. For example, in some instances, a first agent can include a lightweight agent operating on a client device and may have permission to access data stored on the device, while one or more second agents may lack such access permission.

In some instances, the first agent can perform iterative refinement of one or more outputs, both with and without the help of a second agent. For example, in some instances, the first agent can generate an initial draft output (e.g., predicted second-agent output, first-agent output, etc.). In some instances, the first agent can perform one or more edits of the initial draft output, such as predicted edits that a second agent would be likely to perform if the draft output was provided to the second agent. In some instances, the lightweight first agent can pass an initial draft output or edited draft output to a more powerful second agent for a final edit. In some instances, editing can be performed using parallel processing. For example, a draft output can comprise a plurality of tokens, and editing (e.g., by a second agent) can include using a plurality of processor devices to process the plurality of tokens in parallel (e.g., simultaneously, etc.).

In some instances, the first machine-learned agent can determine whether or not to generate predicted outputs of a second machine-learned agent (e.g., instead of interacting with the second machine-learned agent), or can select between a plurality of second machine-learned agents, based on various factors. For example, in some instances, a first machine-learned agent can decide whether or not to call a second machine-learned agent based on confidence data, such as a confidence (e.g., numerical probability value) that one or more predicted outputs generated by the first machine-learned agent will be accurate. As another example, the first machine-learned agent can generate a predicted output of the second machine-learned agent, without calling the second machine-learned agent, when an input includes private data (e.g., private user data, etc.) that the first agent has permission to access and the second agent cannot access. As another example, the first machine-learned agent can choose between second agents, or choose whether or not to call a second agent at all, based on one or more of cost data (e.g., financial cost to a user, computational cost, etc.), timing data (e.g., latency data, throughput data), past success or failure data, agent availability data (e.g., network outage data, subscription login data, API key data, etc.), agent capabilities (e.g., task type specialties, data access capabilities, capability of processing particular data types such as image, video, etc.), one or more respective amounts of interaction data collected so far (e.g., to encourage data collection where data is sparse, to encourage diversity of interactions, etc.), or other appropriate factors.

In some instances, one or more outputs can be provided to a user, and a computing system can receive user feedback indicating whether the user is satisfied or dissatisfied with the outputs. In some instances, if a user is dissatisfied, the first agent can regenerate new outputs based on the same user input used to generate the unsatisfactory outputs. In some instances, actions taken to generate the new outputs can be the same as or different from actions taken to generate the first outputs. For example, in some instances, a computing device can use lower-cost actions, such as using a lightweight first agent to imitate more powerful or higher-cost second agents or other tools, to generate the first outputs, and can switch to higher-cost actions only in the event of user dissatisfaction. As another example, in some instances, a first agent can select between actions (e.g., between imitating and calling second agents, etc.) to minimize an estimated total cost (e.g., computational cost, financial cost, latency cost, loss function or cost function value, etc.) of reaching user satisfaction.

Systems and methods according to aspects of the present disclosure can be applied to a variety of fields of application, such as image processing (e.g., image generation, visual question answering, visual identification such as facial recognition, image captioning, etc.), audio processing (e.g., audio generation such as speech or music generation, speech-to-text or text-to-speech processing, audio identification such as voice identification, etc.), video processing (e.g., video generation, etc.), sequence processing (e.g., natural language sequence generation, natural language translation, question answering, computer code generation, etc.), robotics (e.g., robotic systems comprising machine-learned agent(s) configured to control physical manipulation tools, etc.), mobile digital assistants (e.g., smart phone assistants configured to perform communication actions, navigation actions, calendar actions, smart appliance control actions, etc.) or other fields of application.

Systems and methods according to some aspects of the present disclosure can provide a variety of technical effects and benefits, such as reduced computational cost (e.g., electricity cost, memory usage, processor usage, latency, etc.); improved technical performance (e.g., inference accuracy, output quality, task performance accuracy, etc.); or improved data privacy compared to some alternative implementations.

For example, in some instances, systems and methods according to some aspects of the present disclosure can provide reduced computational cost (e.g., electricity cost, memory usage, processor usage, latency, etc.) compared to some alternative implementations. For example, in some instances, systems and methods according to some aspects of the present disclosure can use a first agent to generate a predicted output of a second agent, without using the second agent in any manner. In some instances, using the first agent to generate the predicted output can provide a reduced computational cost compared to some alternative implementations. For example, in some instances, a first agent can include a lightweight agent having a reduced computational cost (e.g., reduced electricity cost, reduced memory footprint, reduced processor usage, latency, etc.) compared to a second agent. As another example, in some instances, a first agent can include a local machine-learned agent and a second agent can include a remote machine-learned agent that must be accessed over a network. In such instances, using the first agent to generate a predicted output can reduce a communication overhead (e.g., network bandwidth usage, communication latency, etc.) compared to some alternative implementations that may use the second agent to generate a corresponding output.

As another example, in some instances, systems and methods according to some aspects of the present disclosure can provide improved technical performance (e.g., inference accuracy, output quality, task performance accuracy, etc.) compared to some alternative implementations. For example, some alternative implementations may include using only a first machine-learned agent to generate outputs or perform action selections (e.g., without emulating a second machine-learned agent). In some instances, systems and methods according to some aspects of the present disclosure can provide improved technical performance compared to such an alternative implementation by generating a predicted output of a second machine-learned agent (e.g., more powerful machine-learned agent, specialized machine-learned agent that specializes in a particular task type, etc.) and producing an improved output or making an improved action selection based at least in part on the predicted output of the second machine-learned model.

As another example, in some instances, systems and methods according to some aspects of the present disclosure can provide improved data privacy compared to some alternative implementations. For example, in some instances, systems and methods according to some aspects of the present disclosure can determine, based at least in part on privacy data indicating that a second agent should not be permitted to access private data associated with an input context or task, not to use the second agent when performing the task. For example, in some instances, systems and methods according to some aspects of the present disclosure can choose, based at least in part on privacy data indicating that a second agent should not be permitted to access the private data, to generate a predicted output or emulate a thought process of the second agent (e.g., using a first agent that has permission to access the private data). As a non-limiting illustrative example, a first agent can in some instances include a lightweight (e.g., low-parameter-count, low-memory-count, etc.) agent that can be stored on a client device (e.g., smart phone) and can have local access to data stored on the client device, while a second agent can in some instances include a more powerful agent operating on a server device that does not have permission to access data stored on the client device. In this manner, for instance, unauthorized access of private data can be prevented.

As another example, in some instances, systems and methods according to some aspects of the present disclosure can provide improved uptime or reliability compared to some alternative implementations. For example, in some instances, a second agent may be unavailable at one or more times (e.g., a remote agent unavailable during network outages, an overworked agent unavailable during periods of peak usage, etc.). In such instances, using a first agent to generate a predicted output of the second agent can provide improved uptime compared to some alternative implementations (e.g., implementations that may wait for the second agent to become available again).

As used herein, the terms “about,” “approximately,” and similar terms in conjunction with a numerical value refer to within 10 percent of the numerical value.

Various example implementations are described herein with respect to the accompanying Figures.

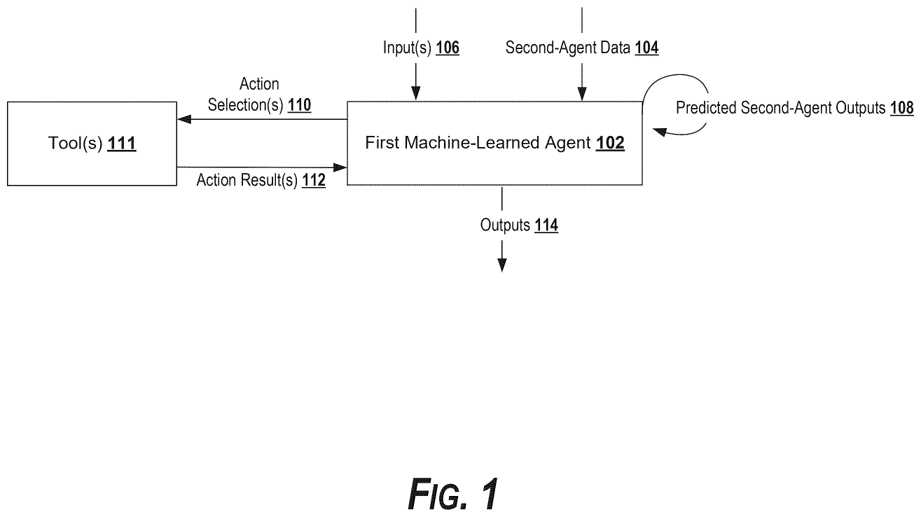

FIG. 1 is a block diagram of an example system for agentic action with a first machine-learned agent based at least in part on predicted outputs associated with a second machine-learned agent according to example implementations of some aspects of the present disclosure. A first machine-learned agent 102 can perform a lightweight form of thought distillation, wherein the first machine-learned agent 102 can receive second-agent data 104 indicative of past interactions of a second machine-learned agent, along with one or more inputs 106. Based on the inputs 106 and second-agent data 104, the first machine-learned agent 102 can generate one or more predicted second-agent outputs 108. Additionally, the first machine-learned agent 102 can make one or more action selections 110, and one or more tools 111 can take one or more actions based on the action selection(s) 110. In some instances, the tools 111 can provide one or more action results 112 to the first machine-learned agent 102. In some instances, the first machine-learned agent 102 can take iterative actions based on the results of previous actions, such as generating predicted second-agent outputs 108 based at least in part on action results 112; making action selections 110 based at least in part on prior action results 112 or predicted second-agent outputs 108; or the like. In some instances, the first machine-learned agent 102 can generate one or more outputs 114 based on one or more of the action results 112 or predicted second-agent outputs 108.

The first machine-learned agent 102 can include one or more machine-learned models. The first machine-learned agent 102 can include various model architectures, such as various neural network model architectures. An example model architecture for a first machine-learned agent 102 can include a sequence processing model architecture (e.g., a transformer model). For example, the first machine-learned agent 102 can be configured to receive an input sequence and generate an output sequence. For instance, the first machine-learned agent 102 can be configured to generate an output sequence where elements of the output sequence are predicted based on the elements of the input sequence. In some instances, a first machine-learned agent 102 can include a generative language model (e.g., natural language model such as text-based, audio-based, or multimodal natural language model). In some instances, a first machine-learned agent 102 can include a model for generating a non-language-based output (e.g., image output, video output, etc.) based on a natural language input (e.g., text, audio, etc.). In some instances, a first machine-learned agent 102 can include a model architecture having an attention mechanism (e.g., self-attention). In some instances, the first-machine-learned agent 102 can include a pre-trained machine-learned model (e.g., pretrained using large-scale unsupervised learning). In some instances, the first machine-learned agent 102 can be fine-tuned over one or more fine-tuning datasets, such as a fine-tuning dataset associated with one or more specialized generation tasks.

In some instances, the first machine-learned agent 102 can include a machine-learned model configured to select an action selection 110 from an action space. In some instances, the first machine-learned agent 102 can include a machine-learned model that has been provided with data indicative of the action space. For example, in some instances, the first machine-learned agent 102 can be provided with action space data as input context, and the first machine-learned agent 102 can select one or more actions based on the input context using in-context learning. As another example, in some instances, the first machine-learned agent 102 can include a machine-learned model that has been trained (e.g., pretrained, fine-tuned, etc.) using data indicative of the action space. In some instances, data indicative of the action space (e.g., data provided via an input context, etc.) can include data associated with one or more tools 111, such as data describing a manner of invoking one or more tools 111, data listing a plurality of actions that can be performed by one or more tools 111, or other data. In some instances, data indicative of the action space (e.g., training data, data provided via an input context, etc.) can include one or more input-output pairs, such as pairs comprising an input context (e.g., user input describing a task to be performed) and a corresponding output value indicative of an action selection 110 (e.g., action name or action identifier associated with the action selection 110; output sequence such as computer code, pseudocode, function call, application programming interface (API) call, or the like; or other action selection output). In some instances, example input-output pairs can be provided as input context to the first machine-learned agent 102 according to one or more prompting techniques (e.g., few-shot prompting, chain-of-thought prompting, etc.). In some instances, the first machine-learned agent 102 can be trained using example input-output pairs, such as by providing an input of an input-output pair to the first machine-learned agent 102; generating, by the first machine-learned agent 102 based at least in part on the input, a training output; determining, by a computing system based at least in part on the training output and an objective function (e.g., loss function based on a comparison between the training output and a ground truth output, etc.), one or more parameter updates for the first machine-learned agent 102; and updating the first machine-learned agent 102 according to the parameter updates.

In some instances, a first machine-learned agent 102 can be configured to select actions or perform task planning using various prompting techniques, such as chain-of-thought prompting (e.g., thought-observation-action prompting, etc.), least-to-most prompting, self-critique, or the like. For example, in some instances, an agent can be prompted with a plurality of example inputs indicative of a task to be performed, along with a plurality of example thought processes for performing the respective tasks. In some instances, each example thought process can include a plurality of delimiters configured to mark each part of the example thought process (e.g., “[Thought],” “[Act],” “[Observe]”; “input:”, “tool choice:”, “tool instruction:”; “1” “2” “3”; etc.). An example thought process can include, for example, one or more planning components; one or more action selection components; one or more action result components; and one or more output components.

In some instances, an example chain-of-thought prompt can include an action selection component comprising an instruction for using one or more tools (e.g., “[Act]: search=‘Paris’”; search(Paris); etc.). In some instances, an example instruction can be in a structured or standardized format, such as a structured or standardized format associated with an action space comprising one or more action selections 110. In some instances, a structured or standardized format can include a format (e.g., syntax, etc.) associated with a computer coding language (e.g., Python, C, etc.); a format associated with an application programming interface (API), a structure associated with a markup language or object notation language (e.g., eXtensible Markup Language (XML), JavaScript Object Notation (JSON), etc.), a structure associated with a pseudocode or interpretable instruction set (e.g., pseudocode or action selection 110 format to be interpreted by glue code associated with the first machine-learned agent 102, etc.), or other structure (e.g., comma-separated value, etc.).

In some instances, a computing system can be configured to receive, from the first machine-learned agent 102, an action selection 110 (e.g., in a structured or standardized format); and cause, responsive to receiving the action selection 110, one or more tools 111 to perform the selected actions. For example, in some instances, a computing system can be configured to receive an executable action selection 110, such as an action selection 110 comprising computer code in a programming language, an action selection 110 comprising an API call, or the like. In some instances, the computing system can execute an executable action selection 110. In some instances, the computing system can perform one or more validation steps before executing an executable action selection 110, such as syntax validation, security validation, or the like.

In some instances, a computing system can be configured to cause one or more tools 111 to perform an action based on an action selection 110 that is not directly executable. For example, in some instances, the computing system can receive, from the first machine-learned agent 102, an action selection 110 indicative of an action to be performed (e.g., action name, action identifier, action parameter(s), etc.); and can cause a tool 111 to perform the action. In some instances, causing the tool 111 to perform the action can include mapping the action selection to corresponding executable code (e.g., corresponding application programming interface (API) call, etc.) and executing the executable code. In some instances, mapping an action selection 110 to executable code can include retrieving corresponding executable code (e.g., corresponding API call, etc.) from a data structure (e.g., database, table, row, column, file, object, etc.) based at least in part in part on the action selection 110 (e.g., based on an action identifier, etc.). In some instances, mapping the action selection 110 to executable code can include passing the action selection 110 to glue code (e.g., glue code comprising one or more compiler, interpreter, or parser functions, etc.) configured to map action selections 110 to executable actions.

In some instances, an output of the agent can be processed to identify and carry out action selections 110. For example, an output of the agent can be parsed (e.g., based on delimiter tags such as “[Act]:” and “[Finish]:”), and one or more action selections 110 can be extracted from the parsed output. In some instances, the parsed output can be checked for correctness (e.g., correct syntax, valid tool name, valid tool inputs, etc.). If a valid action selection 110 is detected, a computing system may cause a tool 111 to perform the selected action.

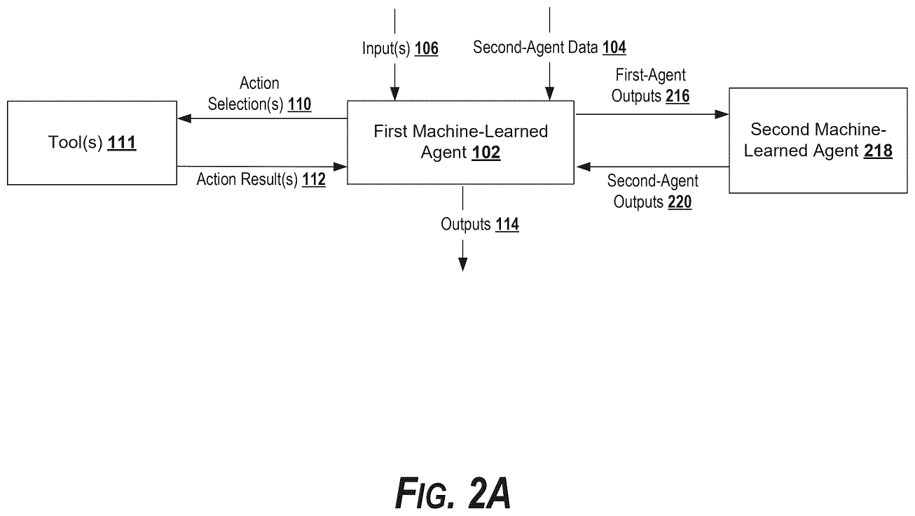

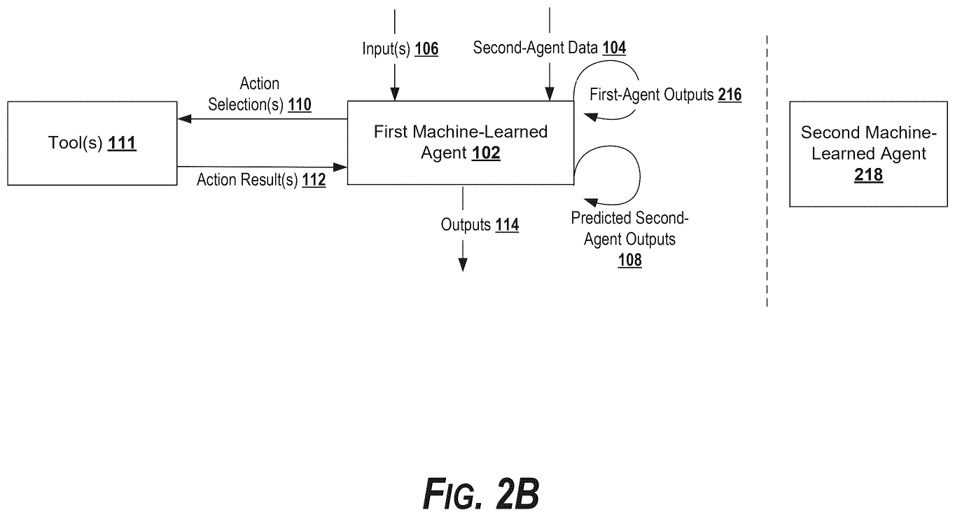

In some instances, a first machine-learned agent 102 can include a machine-learned model having a computational cost, number of parameters, context window size, number of bits per parameter, or other property that is relatively small compared to some other machine-learned agents, such as example machine-learned agents depicted below with respect to FIGS. 2A through 4. For example, in some instances, a first machine-learned agent 102 can have a number of parameters or context window size to facilitate local operation on a mobile device (e.g., smartphone, laptop, tablet, etc.) with relatively limited computational resources compared to enterprise server devices. In some instances, a first machine-learned agent 102 can have a number of parameters or context window size such that an amount of memory (e.g., RAM) required to perform all or part of an inference computation using the first machine-learned agent 102 is smaller than an amount of memory available to the mobile device (e.g., on-chip memory associated with a particular processor device or group of processor devices; memory of the mobile device as a whole; etc.). For example, a context window size can be less than or equal to about 10,000 tokens; less than or equal to about 5,000 tokens; less than or equal to about 4,000 tokens; less than or equal to about 3,000 tokens; less than or equal to about 2,000 tokens; less than or equal to about 1,000 tokens; less than or equal to about 500 tokens; etc. As another example, a number of parameters of the first machine-learned agent 102 can be less than or equal to about 100 billion; less than or equal to about 50 billion; less than or equal to about 25 billion; less than or equal to about 20 billion; less than or equal to about 15 billion; less than or equal to about 10 billion; less than or equal to about 5 billion; less than or equal to about 3 billion; less than or equal to about 1 billion; less than or equal to about 500 million; less than or equal to about 100 million; etc. As another example, a level of quantization can be configured to reduce a memory footprint of the model. For instance, a number of bits used to represent a parameter of the first machine-learned agent 102 can be less than or equal to 32 bits; less than or equal to 16 bits; less than or equal to 8 bits; less than or equal to 4 bits; less than or equal to 2 bits; or 1 bit.

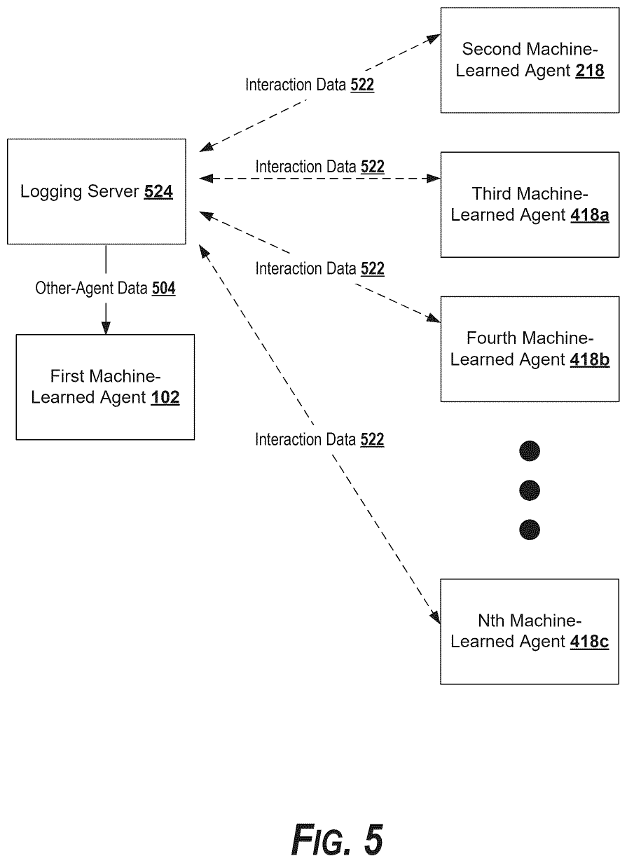

Second-agent data 104 can generally include or otherwise represent various types of data. Second-agent data 104 can include one type or many different types of data. In some instances, second-agent data 104 can include data associated with one or more past interactions of one or more second machine-learned agents, such as interaction log data. For example, in some instances, second-agent data 104 can include interaction log data collected by a first machine-learned agent 102 or by a computing device on which the first machine-learned agent is running. In some instances, second-agent data 104 can include interaction data received from another source, such as a second machine-learned agent or computing device associated with the second machine-learned agent; a logging server; or other system. Further details of an example logging server according to some aspects of the present disclosure are provided below with respect to FIG. 5.

Example data types for second-agent data 104 can include text data (e.g., natural language text data, computer code text data), audio data, image data, video data, multimodal data (e.g., text and image, text and audio, etc.), binary data (e.g., binary computer code data, multimodal data communicated in a binary format, etc.), or other data type or combination of data types. In some instances, second-agent data 104 can include sequence data indicative of one or more past interaction sequences of a second machine-learned agent.

In some instances, second-agent data 104 can include one or more input-output pairs associated with one or more second machine-learned agents. An input-output pair can include, for example, an input context provided to the second machine-learned agent, an input context associated with a particular interaction, or the like. The input-output pair can further include, for example, an output (e.g., action selection 110; text, audio, image, video, or multimodal output; etc.) generated by the second machine-learned agent based on a corresponding input (e.g., during an interaction with a first machine-learned agent 102, during an interaction with another agent, in a non-interactive operation for which log data is available, etc.).

In some instances, second-agent data 104 can include one or more delimiters, such as delimiters identifying one or more authors (e.g., first machine-learned agent 102, second machine-learned agent, etc.) of one or more portions of the interaction data; delimiters delimiting one or more portions of the interaction data that was output by a second machine-learned agent; delimiters identifying one or more portions of the interaction data that was input to the second machine-learned agent; or other delimiter data. As a non-limiting illustrative example, an example interaction log might include a first delimiter such as “Agent 1:” followed by data that was output by a first machine-learned agent 102 and input into a second machine-learned agent; a second delimiter such as “Agent 2:” followed by data that was output by the second machine-learned agent based on the input data; and other delimiters (e.g., plurality of “Agent 1:” and “Agent 2:” delimiters indicative of an interactive conversation, delimiters indicative of a break (e.g., division, separation, etc.) between separate interactions of a second machine-learned agent, “thought” “observation” “action” delimiters indicative of an output type associated with an agent output, delimiters indicative of an input type, etc.).

In some instances, second-agent data 104 can include data associated with a single second agent or a plurality of second agents. For example, in some instances, a plurality of agents can be grouped by agent type (e.g., coding agent, math agent, retrieval agent, mobile digital assistant, etc.), model size (e.g., number of parameters, etc.), model family (e.g., Gemini, T5, etc.), input/output data type(s) (e.g., text, image, audio, video, multimodal, etc.), or other grouping (e.g., agent identifier, geographic grouping, etc.). In some instances, second-agent data 104 can include all interaction data available for a particular second agent, or a subset of available interaction data for the second agent. For example, in some instances, second-agent data 104 can include one or more interaction data subsets determined based on task type, input data type, semantic embedding (e.g., as discussed below with respect to input(s) 106), or other grouping.

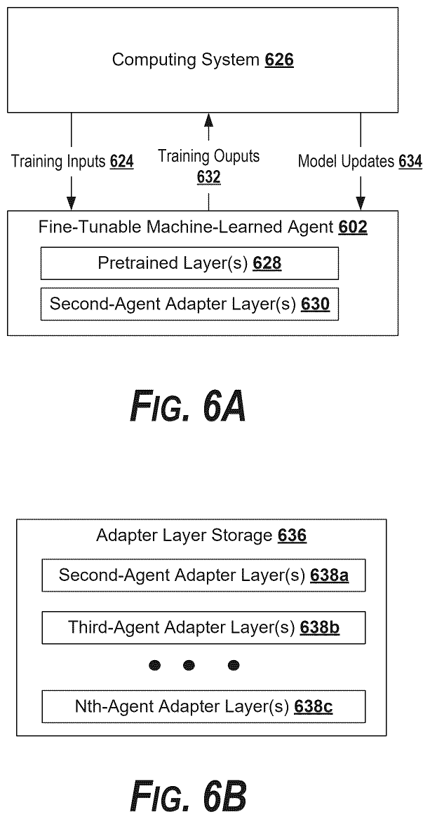

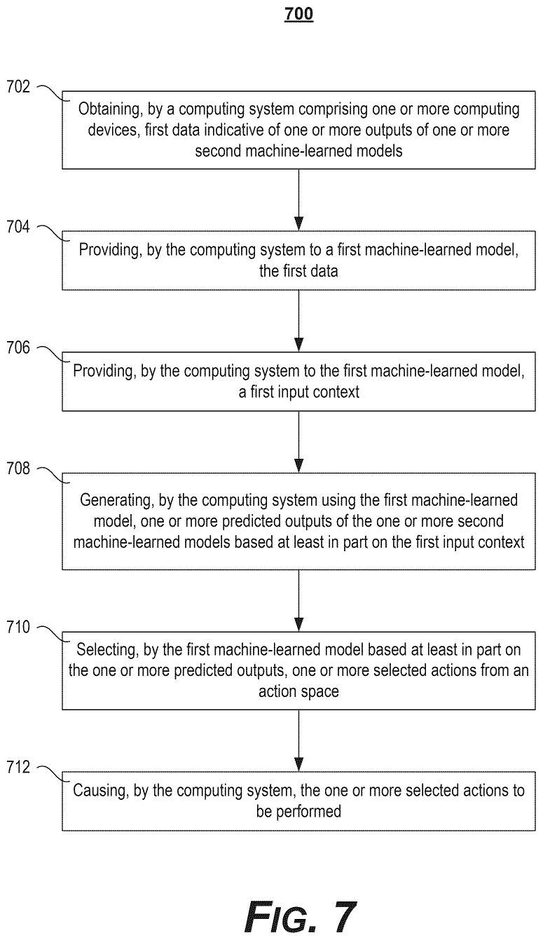

In some instances, second-agent data 104 can be provided to the first machine-learned agent as input context, or can be provided as part of a fine-tuning training process. In some instances, when a total amount of interaction data collected for a particular second agent is small, a computing system may provide all of the collected interaction data to the first machine-learned agent 102 as input context (e.g., in combination with the input(s) 106), and the first machine-learned agent 102 can generate one or more predicted outputs 108 associated with the second agent based on the input context. In some instances, if a total amount of interaction data collected is too large for a context window of the first machine-learned agent 102, a computing system can retrieve a subset of the collected data and provide the subset to the first agent as input context. In some instances, second-agent data 104 can include one or more parameter updates for updating one or more parameters of the first machine-learned agent 102, and providing the second-agent data 104 to the first machine-learned agent 102 can include training (e.g., fine-tuning, etc.) the first machine-learned agent 102 using the second-agent data 104. Further details of an example implementation for fine-tuning a first machine-learned agent 102 according to some aspects of the present disclosure are provided below with respect to FIGS. 6A and 6B.

Input(s) 106 can generally include or otherwise represent various types of data. Input(s) 106 can include one type or many different types of data. Input(s) 106 can include data of the same type(s) or of different types of data as compared to second-agent data 104.

Example data types for input(s) 106 can include text data (e.g., natural language text data, computer code text data), audio data, image data, video data, multimodal data (e.g., text and image, text and audio, etc.), binary data (e.g., binary computer code data, multimodal data communicated in a binary format, etc.), or other data type or combination of data types. In some instances, input(s) 106 can include one or more inputs received from a user.

In some instances, input(s) 106 can include instruction content (e.g., natural language instruction content, such as text or audio natural language content), such as instruction content indicative of a task to be performed. A task can include, for example, a generative task (e.g., image, text, audio, or video generation; multimodal output generation; etc.); a mobile digital assistant task (e.g., add calendar appointment, order goods or service online, search the web, perform a navigation task, etc.); a question-answering (e.g., visual question answering, search-augmented question answering, etc.) or problem-solving task (e.g., mathematical problem, scientific problem, etc.); a computing task; a physical task; or other task type.

In some instances, input(s) 106 can include additional input context, such as in-context learning content. In-context learning content can include, for example, few-shot prompting, chain-of-thought prompting, tool data describing one or more tools 111, action space data describing one or more available actions selections 110 or illustrating an example action selection 110 output, or other in-context learning content.

In some instances, all or part of the second-agent data 104 or input(s) 106 can be retrieved based on one or more earlier inputs, such as an input received from a user. For example, in some instances, a computing system can receive, from a user, a user input describing one or more tasks to be performed. Based at least in part on the user input, the computing system can retrieve one or more of: second-agent data 104 associated with the user input; in-context learning content associated with the user input; other input(s) 106 associated with the user input; or other relevant data.

In some instances, retrieval can be based at least in part on a task type (e.g., mathematical, generative, navigational, etc.) associated with a user input. For example, in some instances, a computing device can receive (e.g., from a user, from an API interaction, from another computing device, etc.) data indicative of a task type, such as a task type identifier. In some instances, the data indicative of the task type can be part of or separate from the input(s) 106. In some instances, a computing device can infer a task type from the input(s) 106. In some instances, inferring a task type from the input(s) 106 can include machine-learned inference (e.g., using a first machine-learned agent 102 or another machine-learned model). In some instances, a task type can be inferred from other data, such as a source (e.g., smartphone application, API, etc.) from which the input(s) 106 were received. In some instances, a first machine-learned agent 102 can generate a predicted second-agent output 108 that is associated with a specialized second agent, such as a second agent that has been fine-tuned using task data associated with a task type associated with the input(s) 106. In some instances, a first machine-learned agent 102 can select an action associated with one or more specialized tools 111 associated with the task type. In some instances, a computing system can retrieve (e.g., using a task type identifier, etc.) and provide to the first machine-learned agent 102, as part of the input(s) 106, specialized in-context learning content associated with a task type, such as task-specific example input-output pairs, task-specific example action selections 110, task-specific API data, or the like.

In some instances, retrieval can be based on one or more semantic similarity metrics, such as a metric of similarity between a machine-learned embedding associated with a user input and a machine-learned embedding associated with the data retrieved (e.g., second-agent data 104, input(s) 106, etc.). For example, in some instances, a computing system can provide one or more user inputs to a machine-learned embedding model to generate a machine-learned embedding. A machine-learned embedding can include, for example, a tensor (e.g., vector, etc.) of numbers output by one or more layers (e.g., intermediate layers, output layers, etc.) of a machine-learned model based on the user inputs. In some instances, the machine-learned embedding of the user input(s) can be compared to one or more stored embeddings of stored in-context learning content or other input 106 values. For example, in some instances, one or more data entries of a data structure (e.g., database such as vector database, etc.) comprising stored input 106 values can be retrieved based on a similarity metric between a machine-learned embedding associated with a user input and respective machine-learned embeddings associated with the stored input 106 values. In some instances, a similarity metric can include a distance metric (e.g., vector distance metric), such as cosine distance, Euclidean distance, or other distance metric. In some instances, a machine-learned embedding can include a unimodal machine-learned embedding (e.g., embedding of a text-only input, audio-only input, image-only input, etc.) or multimodal machine-learned embedding (e.g., contrastive language-image pretraining (CLIP) embedding of text and image data, etc.).

Predicted second-agent output(s) 108 can generally include or otherwise represent various types of data. Predicted second-agent output(s) 108 can include one type or many different types of data. Predicted second-agent output(s) 108 can include data of the same type(s) or of different types of data as compared to input(s) 106 or second-agent data 104. Example data types for predicted second-agent output(s) 108 can include text data (e.g., natural language text data, computer code text data), audio data, image data, video data, multimodal data (e.g., text and image, text and audio, etc.), binary data (e.g., binary computer code data, multimodal data communicated in a binary format, etc.), or other data type or combination of data types.

In some instances, the predicted second-agent outputs 108 can include one or more values that the first machine-learned agent 102 predicts that a second agent would output if provided with the input(s) 106. The predicted second-agent outputs 108 can be generated, for example, based on second-agent data 104 provided as input context to the first machine-learned agent 102; second-agent data provided to the first machine-learned agent via a training process (e.g., fine-tuning process); or other data. In some instances, a computing device can cause the first machine-learned agent 102 to generate predicted second-agent outputs 108 by providing the first machine-learned agent 102 with input(s) 106 comprising one or more delimiters (e.g., dummy delimiters, substitute delimiters, false delimiters) associated with the second agent. As used herein, a dummy delimiter, substitute delimiter, or false delimiter can refer to a delimiter that indicates (e.g., falsely indicates, purports to indicate, etc.) that a second machine-learned agent other than the first machine-learned agent 102 will generate one or more next tokens, wherein the delimiter is provided to the first machine-learned agent 102 to cause the first machine-learned agent 102 to generate the one or more next tokens. Similarly, as used herein, a false delimiter, dummy delimiter, or substitute delimiter can refer to a delimiter that consistently or repeatedly preceded outputs of one or more second machine-learned agents other than the first machine-learned agent 102 throughout a plurality of data examples (e.g., training examples used to train the first machine-learned agent 102, data examples provided as input context to the first machine-learned agents 102, etc.) or throughout a body of second-agent data 104, wherein the delimiter is provided to the first machine-learned agent 102 to cause the first machine-learned agent 102 to generate one or more outputs to follow the delimiter. The delimiters can include, for example, delimiters that appear in association with (e.g., immediately preceding in a sequence) one or more (e.g., all) outputs of a second agent that are included in the second-agent data 104. As a non-limiting illustrative example, the second-agent data 104 can include the delimiter “Agent 2:” before each output of the second agent (e.g., in addition to other delimiters before other content, such as “Agent 1:”, “User:”, etc.), and a computing device can cause the first machine-learned agent 102 to produce a predicted second-agent output 108 by including the delimiter “Agent 2:” in one or more input(s) 106 (e.g., at the end of an input 106). However, this is not required. For example, in some instances, a first machine-learned agent 102 can include a fine-tuned agent that has been fine-tuned to imitate a second machine-learned agent without specialized prompting, such that the first machine-learned agent 102 generates a predicted second-agent output 108 in response to input(s) 106 that do not end with any special delimiter. Further details of some example fine-tuned machine-learned agents according to some aspects of the present disclosure are provided below with respect to FIGS. 6A and 6B.

Action selection(s) 110 can generally include or otherwise represent various types of data. Action selection(s) 110 can include one type or many different types of data. Action selection(s) 110 can include data of the same type(s) or of different types of data as compared to predicted second-agent output(s) 108, input(s) 106 or second-agent data 104.

An action selection 110 can include, for example, any data indicative of a selected action to be performed by one or more tools 111. In some instances, an action selection 110 can include an executable action selection 110, such as executable computer code, API calls, network requests (e.g., hypertext transfer protocol requests, etc.), or the like. In some instances, an action selection 110 can include other data indicative of a selected action, such as an action name or identifier; one or more action parameters; an action description (e.g., natural language description, structured description, etc.); or the like. For example, in some instances, a first machine-learned agent 102 can include a machine-learned sequence processing model configured to output text sequences (e.g., text-only machine-learned model, multimodal machine-learned model), and an action selection 110 can include a text representation of a selected action. A text representation of a selected action can include, for example, text comprising executable code (e.g., API call, computer code associated with a programming language, etc.); text comprising an action name, action identifier, action description, action parameters, or the like; or other text representation.

A tool 111 can be or include, for example, one or more software, firmware, or hardware components configured to perform an action associated with an action selection 110. In some instances, a tool 111 can be or include an API tool that can be accessed via an API. In some instances, the tool 111 can be or include a tool that is configured to execute computer code (e.g., Python code, Java code, machine code, object code, assembly code, etc.) generated by the first machine-learned agent 102, such as a compiler, interpreter, virtual machine, container, integrated development environment, or other tool for executing computer code. In some instances, a tool 111 can include glue code configured to perform or cause to be performed one or more actions associated with an action selection 110 that does not comprise executable code. For example, in some instances, a tool 111 can include glue code configured to identify (e.g., via parsing, interpreting, etc.) one or more selected actions or other data (e.g., selected action parameters, etc.) associated with an action selection 110; map the data to one or more executable actions (e.g., computer code, API calls, etc.); and perform or cause to be performed (e.g., using a compiler, API tool, etc.) the one or more executable actions.

In some instances, a tool 111 can include a tool 111 configured to perform various types of actions, such as image processing (e.g., image generation, visual question answering, visual identification such as facial recognition, image captioning, etc.), audio processing (e.g., audio generation such as speech or music generation, speech-to-text or text-to-speech processing, audio identification such as voice identification, etc.), video processing (e.g., video generation, etc.), sequence processing (e.g., natural language sequence generation, natural language translation, question answering, computer code generation, etc.), robotics (e.g., robotic systems comprising machine-learned agent(s) configured to control physical manipulation tools, etc.), mobile digital assistants (e.g., smart phone assistants configured to perform communication actions, navigation actions, calendar actions, smart appliance control actions, etc.) or other action type. For example, in some instances, an action selection 110 can include an image processing action (e.g., generating an image, generating an image caption based on an input image, generating a text-based answer based on an input image and input question, generating a binary mask indicative of one or more objects identified in an input image, etc.), an audio processing action (e.g., synthesizing audio waveforms such as speech waveforms or music waveforms, generating a text output such as speech-to-text output based on input audio, audio identification action, etc.), video processing action (e.g., synthesizing a video output, such as a video output comprising one or more audio waveforms, based at least in part on input(s) 106, etc.), sequence processing action (e.g., synthesizing a natural language sequence, translating a natural language from a first natural language (e.g., English, etc.) to a second natural language (e.g., French, etc.), synthesizing a computer code sequence based at least in part on input(s) 106, question answering action, etc.), robotics action (e.g., causing a physical device to perform a physical action such as a physical movement, etc.), mobile digital assistant action (e.g., causing a device such as a smart appliance or smart television to perform a physical action, navigation actions, calendar actions, making a telephone call over a telephone network such as a wireless network, transmitting a text message or email over a communication channel (e.g., short message service, multimedia message service, internet, etc.), or other action (e.g., software action, firmware action, computer hardware action, etc.).

Action result(s) 112 can generally include or otherwise represent various types of data. Action result(s) 112 can include one type or many different types of data. Action result(s) 112 can include data of the same type(s) or of different types of data as compared to predicted second-agent output(s) 108, input(s) 106, second-agent data 104.

Example data types for action result(s) 112 include text data (e.g., natural language text data, computer code text data), audio data, image data, video data, multimodal data (e.g., text and image, text and audio, etc.), binary data (e.g., binary computer code data, multimodal data communicated in a binary format, etc.), or other data type or combination of data types.

In some instances, action result(s) 112 can include success/failure data indicative of whether or not a task was successfully performed, such as error message data, success confirmation data, error code data, or the like. In some instances, action result(s) 112 can include retrieved data (e.g., data retrieved over the internet or other communication channel, data retrieved from a data structure, data retrieved via an API, etc.), generated data (e.g., data generated using a machine-learned model, etc.), sensor data (e.g., weather data, etc.), or other action result data. In some instances, action result(s) 112 can include action output data that is output by one or more tools 111 in performing a selected action.

In some instances, a first machine-learned agent 102 can perform a recursive or iterative process, wherein one or more later actions of the first machine-learned agent 102 are based at least in part on a result of one or more earlier actions of the first machine-learned agent 102. For example, in some instances, an action selection 110 can be based at least in part on an earlier predicted second-agent output 108. In some instances, a later predicted second-agent output 108 can be based at least in part on an earlier predicted second-agent output 108. In some instances, a later action selection 110 can be based at least in part on an earlier action result 112.

In some instances, a determination of when to end an iterative process can be made by the first machine-learned agent 102. For example, in some instances, an action space from which a first machine-learned agent 102 makes an action selection 110 can include an output action or terminate action, wherein an iterative process ends or an output 114 is provided (e.g., to a user, to a computing device, to an API, etc.). In some instances, an action selection 110 can include action selection data (e.g., action name, action identifier, etc.) indicative of an output action or terminate action. In some instances, an action selection 110 associated with an output action can further include an output 114 (e.g., as an action parameter, etc.).

In some instances, in-context learning (e.g., chain-of-thought prompting, least-to-most prompting, etc.) can be used to cause the first machine-learned agent 102 to perform an iterative process in which the first machine-learned agent 102 generates one or more earlier or later predicted second-agent outputs 108; one or more earlier or later action selections 110; and one or more outputs 114. For example, in some instances, a chain-of-thought prompt can include one or more example action chains comprising one or more earlier or later predicted second-agent outputs 108; one or more earlier or later action selections 110; and one or more outputs 114. In some instances, each example thought process can include a plurality of delimiters configured to mark each part of the example thought process (e.g., “[Thought],” “[Act],” “[Observe]”, “[Output]”; “input:”, “tool choice:”, “tool instruction:”; “1” “2” “3”; etc.). An example thought process can include, for example, one or more planning components; one or more action selection components; one or more action result components; and one or more output components.

Output(s) 114 can generally include or otherwise represent various types of data. Output(s) 114 can include one type or many different types of data. Output(s) 114 can include data of the same type(s) or of different types of data as compared to predicted second-agent output(s) 108, input(s) 106, second-agent data 104. Example data types for output(s) 114 can include text data (e.g., natural language text data, computer code text data), audio data, image data, video data, multimodal data (e.g., text and image, text and audio, etc.), binary data (e.g., binary computer code data, multimodal data communicated in a binary format, etc.), or other data type or combination of data types.

FIG. 2A is a block diagram of an example system for interactive agentic action in a multi-agent environment according to example implementations of some aspects of the present disclosure. A first machine-learned agent 102 can receive inputs 106 or second-agent data 104. The first machine-learned agent 102 can interact with a second machine-learned agent 218, such as by inputting one or more first-agent outputs 216 of the first machine-learned agent 102 and receiving one or more second-agent outputs 220 generated by the second machine-learned agent 218 based on the first-agent outputs 216. Additionally, the first machine-learned agent 102 can make one or more action selections 110, and one or more tools 111 can take one or more actions based on the action selection(s) 110. In some instances, the tools 111 can provide one or more action results 112 to the first machine-learned agent 102. In some instances, the first machine-learned agent 102 can take iterative actions based on the results of previous actions, such as interacting with a second machine-learned agent 218 based at least in part on action results 112; making action selections 110 based at least in part on prior action results 112 or second-agent outputs 220; or the like. In some instances, the first machine-learned agent 102 can generate one or more outputs 114 based on one or more of the action results 112 or second-agent outputs 220.

A first-agent output 216 or second-agent output 220 can generally include or otherwise represent various types of data. A first-agent output 216 or second-agent output 220 can include one type or many different types of data. A first-agent output 216 or second-agent output 220 can include data of the same type(s) or of different types of data as compared to predicted second-agent output(s) 108, input(s) 106, second-agent data 104. Example data types for first-agent outputs 216 or second-agent outputs 220 can include text data (e.g., natural language text data, computer code text data), audio data, image data, video data, multimodal data (e.g., text and image, text and audio, etc.), binary data (e.g., binary computer code data, multimodal data communicated in a binary format, etc.), or other data type or combination of data types.

In some instances, a first-agent output 216 can be, comprise, be comprised by, or otherwise share one or more properties with an output 114, predicted second-agent output 108, action selection 110, or other value generated by a first machine-learned agent 102. For example, in some instances, a first-agent output 216 can have any property described above with respect to one or more of an output 114, predicted second-agent output 108, and an action selection 110. In some instances, a method for generating a first-agent output 216 can have any property described above with respect to a method for generating one or more of an output 114, predicted second-agent output 108, and an action selection 110.

In some instances, a second-agent output 220 can include a true output of the second machine-learned agent 218 (i.e., an output that is generated by the second machine-learned agent 218, e.g., in contrast to a predicted second-agent output 108 generated by a first machine-learned agent 102). In some instances, a second-agent output 220 or method for using a second-agent output 220 can have any property described above with respect to a predicted second-agent output 108 or a method for using a predicted second-agent 108.

In some instances, a first machine-learned agent 102 and second machine-learned agent 218 can work together to perform a recursive or iterative process, wherein one or more later actions of the first machine-learned agent 102 or second machine-learned agent 218 are based at least in part on a result of one or more earlier actions of the first machine-learned agent 102 or second machine-learned agent 218. For example, in some instances, an action selection 110 can be based at least in part on an earlier first-agent output 216 or second-agent output 220. In some instances, a later first-agent output 216 or second-agent output 220 can be based at least in part on an earlier first-agent output 216 or second-agent output 220. In some instances, a later action selection 110 or first-agent output 216 or second-agent output 220 can be based at least in part on an earlier action result 112. In some instances, a determination of when to end an iterative process can be made by the first machine-learned agent 102 or second machine-learned agent 218 (e.g., as described above with respect to FIG. 1).

In some instances, in-context learning (e.g., chain-of-thought prompting, least-to-most prompting, etc.) can be used to cause the first machine-learned agent 102 and second machine-learned agent 218 to perform an iterative process in which the first machine-learned agent 102 or second machine-learned agent 218 generates one or more earlier or later predicted first-agent outputs 216 or second-agent outputs 220; one or more earlier or later action selections 110; and one or more outputs 114. For example, in some instances, a chain-of-thought prompt can include one or more example action chains comprising one or more earlier or later first-agent outputs 216 or second-agent outputs 220; one or more earlier or later action selections 110; and one or more outputs 114. In some instances, each example thought process can include a plurality of delimiters configured to mark each part of the example thought process (e.g., “[Thought],” “[Act],” “[Observe]”, “[Output]”; “input:”, “tool choice:”, “tool instruction:”; “1” “2” “3”; etc.). An example thought process can include, for example, one or more planning components; one or more action selection components; one or more action result components; and one or more output components.

In some instances, the second machine-learned agent 218 can be provided with input content (e.g., input(s) 106, in-context learning content, etc.) that is the same as or different from input content provided to the first machine-learned agent 102. For example, in some instances, a first machine-learned agent 102 or computing device associated with the first machine-learned agent 102 can provide, to a second machine-learned agent, input context comprising the same input(s) 106 provided to the first machine-learned agent 102, along with other data such as first-agent outputs 216, action results 112, instruction content that may be specific to the second machine-learned agent 218 (e.g., an instruction to edit a first-agent output 216, etc.), or other data. Other implementations are possible.

In some instances, an iterative process can include one or more edits performed by the first or second machine-learned agents 102, 218. For example, in some instances, a first machine-learned agent 102 can generate a draft action plan (e.g., action plan associated with a thought-observation-action model, etc.), and a second machine-learned agent 218 can generate an edited action plan based on the draft action plan. In some instances, a first machine-learned agent 102 can generate a draft action selection 110, and a second machine-learned agent 218 can generate an edited action selection 110 based on the draft action selection 110. In some instances, a first machine-learned agent 102 can perform one or more edits of its own outputs, such as generating an edited action plan or action selection 110 based on a draft action plan or action selection 110 produced by the first machine-learned agent 102. In some instances, the first machine-learned agent 102 can perform one or more preliminary edits before passing to the second machine-learned agent for one or more additional edits. In some instances, the preliminary edits can be predicted second-agent outputs 108 indicative of an edit the second machine-learned agent 218 is likely to perform, or can be first-agent outputs 216 that are not based on second-agent data 104 or associated with the second machine-learned agent 218.

In some instances, one or more edited values can be generated using parallel processing. For example, in some instances, a draft output value (e.g., draft action plan, draft action selection 110, draft first-agent output 216, etc.) can comprise a plurality of draft tokens, and editing can include using a plurality of processor devices to process the plurality of draft tokens in parallel (e.g., simultaneously, etc.). For example, in some instances, a draft output value can include an output sequence, and one or more first processors can process, during a first time period, the draft output value (e.g., using the first or second machine-learned agent 102, 218) to determine one or more scores (e.g., likelihood values, token probabilities indicative of a respective probability that a second machine-learned agent would output a respective draft token, predicted objective function values, numerical scores, etc.) associated with a first token of the sequence; one or more second processors can determine, during the first time period, one or more scores (token probability, etc.) associated with a second token of the sequence; one or more third processors can determine, during the first time period, one or more scores associated with a third token of the sequence; and so on.

The second machine-learned agent 218 can include one or more machine-learned models. The second machine-learned agent 218 can include various model architectures, such as various neural network model architectures. An example model architecture for a second machine-learned agent 218 can include a sequence processing model architecture (e.g., a transformer model). For example, the second machine-learned agent 218 can be configured to receive an input sequence and generate an output sequence. For instance, the second machine-learned agent 218 can be configured to generate an output sequence where elements of the output sequence are predicted based on the elements of the input sequence. In some instances, a second machine-learned agent 218 include a generative language model (e.g., natural language model such as text-based, audio-based, or multimodal natural language model). In some instances, a second machine-learned agent 218 can include a model for generating a non-language-based output (e.g., image output, video output, etc.) based on a natural language input (e.g., text, audio, etc.). In some instances, a second machine-learned agent 218 can include a model architecture having an attention mechanism (e.g., self-attention). In some instances, the second machine-learned agent 218 can be a pre-trained model (e.g., pretrained using large-scale unsupervised learning). In some instances, the second machine-learned agent 218 can be fine-tuned over one or more fine-tuning datasets, such as a fine-tuning dataset associated with one or more specialized generation tasks.

In some instances, the second machine-learned agent 218 can have an architecture that is the same as or different from the first machine-learned agent 102. In some instances, the second machine-learned agent 218 can include an agent that has been fine-tuned for one or more specialized tasks, such as specialized tasks for which the first machine-learned agent 102 has not been fine-tuned. In some instances, the second machine-learned agent 218 can have one or more data access permissions that are the same as or different from one or more data access permissions of the first machine-learned agent 102. For example, in some instances, the first machine-learned agent 102 may have permission to access data (e.g., private data, confidential data, etc.) that is unavailable to the second machine-learned agent 218. In some instances, the second machine-learned agent 218 may have access to data (e.g., real-time data, proprietary data, API data, etc.) that may be unavailable to the first machine-learned agent 102.

In some instances, a second machine-learned agent 218 can comprise a machine-learned model having a computational cost, number of parameters, context window size, number of bits per parameter, or other property that is relatively large compared to some other machine-learned agents, such as a first machine-learned agent 102. For example, a context window size can be greater than or equal to about 1,000 tokens; such as greater than or equal to about 5,000 tokens; such as greater than or equal to about 10,000 tokens; such as greater than or equal to about 20,000 tokens; such as greater than or equal to about 50,000 tokens; such as greater than or equal to about 100,000 tokens. As another example, a number of parameters of the first machine-learned agent 102 can be greater than or equal to 100 billion; such as greater than or equal to about 200 billion; such as greater than or equal to about 500 billion; such as greater than or equal to about 1 trillion; such as greater than or equal to about 2 trillion. In some instances, a number of bits per parameter of the second machine-learned agent 218 can be the same as or different from (e.g., larger than, etc.) a number of bits per parameter of the first machine-learned agent 218. For example, in some instances, a number of bits per parameter of the second machine-learned agent can be greater than or equal to about 4 bits; such as greater than or equal to about 8 bits; such as greater than or equal to about 16 bits.

In some instances, a second machine-learned agent 218 can be, comprise, be comprised by, or otherwise share one or more properties with a tool 111. For example, in some instances, a second machine-learned agent 218 can have any property described herein with respect to a tool 111, and vice versa. For example, in some instances, an action selection 110 can include a selection of an action comprising interacting with a second machine-learned agent 218, such as an action comprising inputting a first-agent output 216 to the second machine-learned agent 218; inputting an input 106 or other data to the second machine-learned agent 218; inputting instruction content (e.g., comprising an instruction to edit a first-agent output 216 or predicted second-agent output 108, etc.) to the second machine-learned agent 218; or other interaction. Similarly, in some instances, a first machine-learned agent 102 can be, comprise, be comprised by, or otherwise share one or more properties with a tool 111. For example, in some instances, a first machine-learned agent 102 can make an action selection 110 comprising a selection of a self-prompting action, such as an action in which the first machine-learned agent 102 is prompted with input context (e.g., instruction content, in-context learning content, etc.) associated with (e.g., retrieved based on, etc.) the action selection 110.

FIG. 2B is a block diagram of an example system for single-agent action based at least in part on interaction data from a multi-agent environment according to example implementations of some aspects of the present disclosure. A first machine-learned agent 102 can receive inputs 106 or second-agent data 104. The first machine-learned agent 102 can simulate an interaction with a second machine-learned agent 218, such as by generating one or more first-agent outputs 216, and generating one or more predicted second-agent outputs 108 (e.g., predicted outputs 108 based on the first-agent outputs 216, etc.). Additionally, the first machine-learned agent 102 can make one or more action selections 110, and one or more tools 111 can take one or more actions based on the action selection(s) 110. In some instances, the tools 111 can provide one or more action results 112 to the first machine-learned agent 102. In some instances, the first machine-learned agent 102 can take iterative actions based on the results of previous actions, such as generating predicted second-agent outputs 108 based on first-agent outputs 216 and vice versa; making action selections 110 based at least in part on prior action results 112, first-agent outputs 216, or predicted second-agent outputs 108; or the like. In some instances, the first machine-learned agent 102 can generate one or more outputs 114 based on one or more of the action results 112 or other values (e.g., first-agent outputs 216, predicted second-agent outputs 108, etc.).

In some instances, the first machine-learned agent 102 can perform any action described above with respect to FIGS. 1 and 2A. For example, in some instances, the first machine-learned agent 102 can perform any process (e.g., an iterative process, etc.) described above with respect to FIG. 2A, except that each action performed by the second machine-learned agent 218 can be performed instead by the first machine-learned agent 102, and any second-agent output 220 can be substituted with a predicted second-agent output 108.

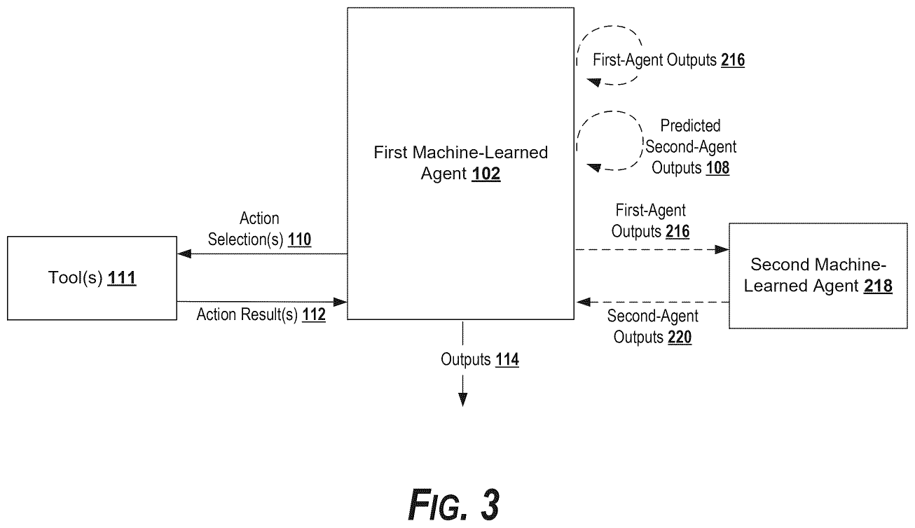

In some instances, a first machine-learned agent 102 or computing system associated with the first machine-learned agent 102 can adaptively determine whether to use or not use a second machine-learned agent 218. Such a determination can be based on various factors, such as input(s) 106, network outage data, privacy data, confidence data, or other factors. Further details of an example system for selecting whether or not to use a second machine-learned agent 218 are provided below with respect to FIG. 3.

FIG. 3 is a block diagram of an example system for adaptively selecting between single-agent action and interactive multi-agent action in a multi-agent environment according to example implementations of some aspects of the present disclosure. A first machine-learned agent 102 can receive inputs 106 or second-agent data 104. The first machine-learned agent 102 can interact with a second machine-learned agent 218 (e.g., in a manner described above with respect to FIG. 2A), simulate an interaction with the second machine-learned agent 218 (e.g., in a manner described above with respect to FIG. 2B), or both (e.g., engage in one or more interactions before or after simulating one or more interactions, etc.). Additionally, the first machine-learned agent 102 can make one or more action selections 110 and receive corresponding action results 112 from tools 111. In some instances, the first machine-learned agent 102 can take iterative actions based on the results of previous actions, such as simulating or engaging in a multi-agent interaction based on a prior simulated or genuine multi-agent interaction; simulating or engaging in a multi-agent interaction based on action results 112; making an action selection 110 based on a prior simulated or genuine multi-agent interaction; or the like.

In some instances, a computing system can select between using and not using a second machine-learned agent 218 based on one or more confidence values associated with one or more predicted second-agent outputs 108. For example, in some instances, a confidence (e.g., numerical probability value, etc.) that one or more predicted second-agent outputs 108 will be correct can be compared to a confidence threshold (e.g., probability threshold, etc.), and a second machine-learned agent 218 can be called if the confidence is below the threshold. In some instances, the confidence can be determined before the predicted second-agent outputs 108 are generated (e.g., using sample size data, historical accuracy data, etc.). In some instances, the confidence can be determined during or after generation of the predicted second-agent outputs 108 (e.g., based on one or more outputs or intermediate values generated by the first machine-learned agent 102). For example, in some instances, a first machine-learned agent 102 can generate one or more machine-learned probability values (e.g., softmax probability values, etc.) during generation of the predicted second-agent outputs 108, and a confidence value can be determined based at least in part on the machine-learned probability values.

In some instances, a computing system can select between using and not using a second machine-learned agent 218 based at least in part on privacy data. For example, in some instances, a computing system can determine that the input(s) 106 comprise private data to which the second machine-learned agent 218 does not have access, and the computing system can decide, based on that determination, to generate predicted second-agent outputs 108 without calling the second machine-learned agent 218. In some instances, a computing system can determine whether the input(s) comprise private data based on one or more of access control list data, login data (e.g., username data, password data, etc.), API key data, security certificate data, data indicative of a data source associated with the input(s) 106, or other privacy data.

In some instances, a computing system can select between using and not using a second machine-learned agent 218 based at least in part on availability data (e.g., network outage data, service outage data associated with the second machine-learned agent 218, access permissions data associated with the second machine-learned agent, etc.). For example, in some instances, the computing system can determine that a machine-learned agent 218 is unavailable (e.g., unavailable in general, unavailable to a user associated with the input(s) 106, unavailable to the first machine-learned agent 102, etc.), and can decide based on the unavailability determination to generate one or more predicted second-agent outputs 108 without calling the second machine-learned agent 218. In some instances, determining that a machine-learned agent is unavailable can include determining that a communication channel (e.g., the internet) is inaccessible to a device operating the first machine-learned agent 102; that a user, first machine-learned agent 102, or other entity lacks appropriate access credentials (e.g., username, password, API key, security certificate, etc.) to access the second machine-learned agent 218; or other availability data.

In some instances, one or more outputs 114 can be provided to a user, and a computing system can receive user feedback indicating whether the user is satisfied or dissatisfied with the outputs. In some instances, if a user is dissatisfied, the first machine-learned agent 102 can regenerate new outputs 114 based on input(s) 106 that are similar to (e.g., same as) or different from input(s) 106 used to generate the unsatisfactory outputs. In some instances, a selection between using and not using a second machine-learned agent 218 when regenerating the new outputs 114 can be the same as or different from a selection used to generate the unsatisfactory outputs 114. For example, in some instances, a first machine-learned agent 102 can include a lightweight machine-learned model having a reduced cost (e.g., computational cost, financial cost to a user, etc.) compared to the second machine-learned agent 218. In some instances, a first output 114 can be more likely to be generated using one or more predicted second-agent outputs 108 (e.g., without using a second machine-learned agent 218), and one or more regenerated outputs 114 can be more likely to be generated using a more powerful second machine-learned agent 218. For example, in some instances, a computing system can use lower-cost machine-learned agents 102 or tools 111 by default, and can enable use of higher cost machine-learned agents 218 or tools 111 only in the event of user dissatisfaction with lower-cost outputs 114.

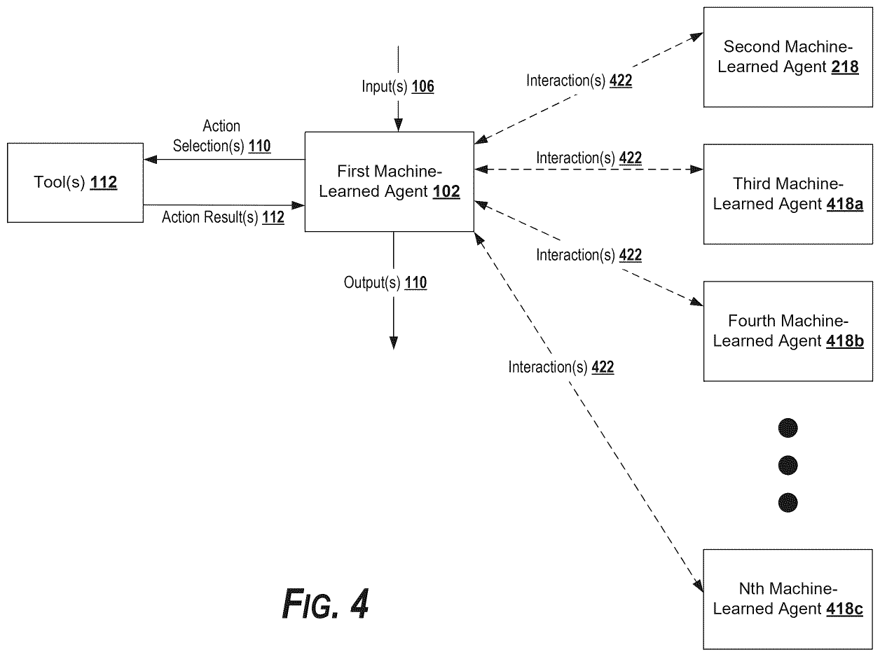

In some instances, a computing system can determine whether or not to use a second machine-learned agent 218 based on other factors, such as one or more of cost data, timing data (e.g., latency data, throughput data), past success or failure data, agent capabilities (e.g., task type specialties, data access capabilities, capability of processing particular data types such as image, video, etc.), an amount of second-agent data 104 collected so far (e.g., to encourage data collection where data is sparse, to encourage diversity of interactions, etc.), or other appropriate factors. In some instances, such a determination can be based on any factor described below with respect to FIG. 4, and can be made in any manner described below with respect to FIG. 4. Although FIG. 4 depicts a computing system selecting between a plurality of machine-learned agents 218, 418, any method of agent selection depicted in FIG. 4 can be equally applicable to the determinations of FIG. 3, and vice versa.

FIG. 4 is a block diagram of an example system for adaptively selecting between a plurality of co-agents in a multi-agent environment according to example implementations of some aspects of the present disclosure. A first machine-learned agent 102 can receive inputs 106. Based on the inputs, the first machine-learned agent 102 can interact with one or more other machine-learned agents 218, 418 (e.g., in a manner described above with respect to FIG. 2A), simulate one or more interactions with the other machine-learned agents 218, 418 (e.g., in a manner described above with respect to FIG. 2B), or both (e.g., engage in one or more interactions before or after simulating one or more interactions, etc.). The first machine-learned agent 102 can select one or more of a plurality of other agents 218, 418 to interact with or simulate an interaction with. Determining a selected machine-learned model can be based on various factors, such as one or more of confidence data, privacy data or network availability data (e.g., as described above with respect to FIG. 3); cost data, timing data (e.g., latency data, throughput data), past success or failure data, agent capabilities (e.g., task type specialties, data access capabilities, capability of processing particular data types such as image, video, etc.), an amount of second-agent data 104 collected so far (e.g., to encourage data collection where data is sparse, to encourage diversity of interactions, etc.), or other appropriate factors.

In some instances, a selection can be based on a single factor. For example, in some instances, a machine-learned agent 218, 418 to interact with or simulate can be selected according to a minimum or maximum rule, such as a minimum cost, minimum latency, maximum success rate, or the like.

In some instances, a selection of a machine-learned agent 218, 418 to interact with or simulate can be based on a combination of factors. For example, in some instances, a plurality of machine-learned agents 218, 418 can be scored based on a plurality of factors, and a machine-learned agent 218, 418 having a minimum or maximum score can be selected. Scoring can include, for example, combining a plurality of values associated with the plurality of factors according to a formula, such as a weighted additive combination formula. In some instances, a selection can be based at least in part on one or more predetermined selection rules. For example, in some instances, one or more first values (e.g., latency values, cost values, specialization values, etc.) associated with one or more first factors can be compared to one or more predetermined thresholds, and one or more machine-learned agents can be qualified or disqualified based on comparisons. In some instances, a computing system can select between the qualified agents based on a minimum or maximum value, a scoring formula, or the like. As a non-limiting illustrative example, an example selection rule can include filtering a plurality of machine-learned agents 218, 418 based on an inference cost threshold, and selecting an agent 218, 418 having a highest historical inference accuracy among agents 218, 418 that satisfy the inference cost threshold. Other implementations are possible.

In some instances, a selection of a machine-learned agent 218, 418 to interact with or simulate can include machine-learned selection. For example, in some instances, a selection can be based at least in part on a machine-learned estimate of one or more values, such as a machine-learned estimate of a total cost of generating a satisfactory output 114 using a particular machine-learned agent 218, 418; a machine-learned estimate of a total latency of generating an output 114; or the like. In some instances, selecting based on a machine-learned estimate can include applying a threshold, scoring formula, rule, or minimum or maximum to the machine-learned estimate.

In some instances, a scoring formula can include a formula for estimating a total cost of generating a satisfactory output 114. For example, in some implementations, a computing system can be configured to receive data indicative of user satisfaction with one or more outputs 114. In some instances, the computing system can be configured to regenerate new outputs 114 responsive to an indication of user dissatisfaction. In some instances, a computing system can select between machine-learned agents 218, 418, or between using and not using a machine-learned agent 218, 418, based on an estimated total cost of reaching a state of user satisfaction. In some instances, an estimated total cost of reaching a state of user satisfaction can be based at least in part on cost data (e.g., cost per output 114 of using or not using a particular machine-learned agent 218, 418, etc.) and based at least in part on success rate data (e.g., historical or estimated user satisfaction rate associated with using or not using a particular machine-learned agent 218, 418, etc.).

Cost data can include, for example, a financial cost (e.g., cost per token to a user associated with the input(s) 106, etc.), a computational cost (e.g., memory usage cost, electricity cost, processor usage cost, etc.), or other cost data (e.g., loss function comprising one or more loss values or cost values, such as financial cost, computational cost, loss value assigned to each occurrence of user dissatisfaction, etc.).

Timing data can include, for example, latency data or throughput data associated with one or more past interactions of a machine-learned agent 218, 418; estimated latency or throughput data associated with the machine-learned agent 218, 418 (e.g., estimated based on data indicative of an amount of one or more computing resources currently available, etc.); or other timing data.

Past success/failure can include, for example, data indicative of a success rate (e.g., user satisfaction rate, objective correctness rate, etc.) associated with interactions of a machine-learned agent 218, 418, such as data indicative of a percentage of satisfactory outputs 114 generated using the machine-learned agent 218, 418 in combination with the first machine-learned agent 102. In some instances, success/failure data can include success level data (e.g., success rate data, etc.) indicative of one or more respective levels of success associated with a particular subset of interactions of the machine-learned agent 218, 418, such as task-specific success level data (e.g., task-specific success rate data) associated with a particular task type (e.g., mathematical task, scientific task, creative writing task, robotics task, navigation task, etc.).

Agent capability data can include, for example, data indicative of one or more task types a machine-learned agent 218, 418 may specialize in (e.g., task types the machine-learned agent 218, 418 has been fine-tuned for, task categories the machine-learned agent 218, 418 has a high success rate in, task types the machine-learned agent 218, 418 is specially prompted for, etc.); data indicative of one or more datasets the machine-learned agent 218, 418 may have or lack access to (e.g., private data, proprietary data, real-time data, sensor data, news data, weather data, internet retrieval data, etc.); data indicative of one or more data types (e.g., natural language, computer code, text, image, audio, video, etc.) the machine-learned agent 218, 418 is configured to process; or other agent capability data.

In some instances, one or more selection factors can be configured to encourage diverse data collection or diverse interactions 422. For example, in some instances, one or more selection rules can be configured to increase a likelihood of selecting a machine-learned agent 218, 418 for which little data has been collected so far, and decrease a likelihood of selecting a machine-learned agent 218, 418 for which ample data has been collected. Similarly, in some instances, one or more selection rules can be configured to increase a likelihood of selecting a machine-learned agent 218, 418 for a task it has rarely performed or for which little data is available, and decrease a likelihood of selecting a machine-learned agent 218, 418 for a task it has performed many times and for which ample data is available.

In some instances, a machine-learned agent 418 can have any property described above with respect to a second machine-learned agent 218, and vice versa. In some instances, each machine-learned agent 418a, 418b, 418c can be a distinct agent that is a different agent from the second machine-learned agent 218 and from each other. In some instances, each machine-learned agent 418 can have one or more properties (e.g., data access permissions, architectures, computational cost properties, fine-tuning properties, task specialization properties, etc.) that are similar to or different from other machine-learned agents 102, 218, 418.

Interactions 422 can include, for example, first-agent outputs 216 or other data sent to a machine-learned agent 218, 418; second-agent outputs 220 received from a machine-learned agent 218, 418; or other interactions between a machine-learned agent 218, 418 and a first-machine-learned agent 102 or computing system implementing the first machine-learned agent 102.

In some instances, one or more selections according to FIG. 4 can be performed instead of or in combination with one or more determinations whether to simulate or call a machine-learned agent 218, 418 as depicted in FIG. 3. For example, in some instances, a computing system can determine which of a plurality of machine-learned agents 218, 418 would be most valuable to use or imitate; and can determine (e.g., after selecting one or more particular machine-learned agents 218, 418) whether to engage in one or more interactions 422 with the selected machine-learned agent(s) (e.g., based on confidence data, cost data, availability data, latency data, etc.).

FIG. 5 is a block diagram of an example system for collecting interaction data in a multi-agent environment according to example implementations of some aspects of the present disclosure. A logging server 524 can receive interaction data 522 from a plurality of machine-learned agents 102, 218, 418. The logging server 524 can provide some or all of the collected interaction data 522 to the first machine-learned agent 102.

In some instances, other-agent data 504 can be, comprise, be comprised by, or otherwise share one or more properties with second-agent data 104. For example, in some instances, other-agent data 504 can have any property described herein with respect to second-agent data 104. In some instances, other-agent data 504 can include data related to third, fourth, or other machine-learned agents 418 that may be different from a second machine-learned agent 218 associated with second-agent data 104.

Interaction data 522 can include, for example, data indicative of one or more interactions 422. In some instances, interaction data 522 can include log data associated with one or more interactions 422. In some instances, interaction data 522 can be, comprise, be comprised by, or otherwise share one or more properties with second-agent data 104. For example, in some instances, interaction data 522 can have any property described herein with respect to second-agent data 104.

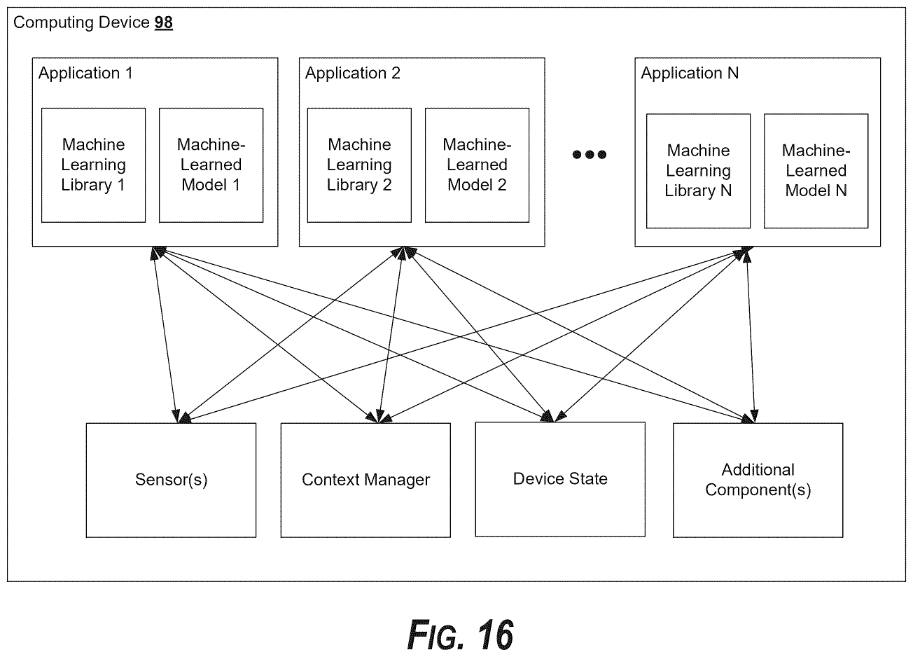

A logging server 524 can be or include one or more software, firmware, or hardware components configured to receive and store interaction data 522 and provide other-agent data 504 to the first machine-learned agent 102. Providing can include, for example, including the other-agent data 504 in input context of the first machine-learned agent 102, fine-tuning the first machine-learned agent 102, or other method of providing. In some instances, the logging server 524 can be, comprise, be comprised by, or share one or more properties with a computing device or system described below with respect to FIGS. 15-17 (e.g., server computing system 60, model development platform system 70, computing device 98, computing device 99, etc.).

FIG. 6A is a block diagram of an example system for fine-tuning a machine-learned agent according to example implementations of some aspects of the present disclosure. A computing system 626 can provide, to a fine-tunable machine-learned agent 602 comprising one or more pretrained layers 628 and one or more second-agent adapter layers 630, training inputs 624. The fine-tunable machine-learned agent 602 can generate, based on the training inputs 624 using the pretrained layers 628 and the second-agent adapter layers 630, one or more training outputs 632. Based on a comparison between the training outputs 632 and one or more objective functions (e.g., loss function comparing the training outputs 632 to one or more ground truth outputs generated by a second machine-learned agent 218, etc.), the computing system 626 can provide one or more model updates 634 to the fine-tunable machine-learned agent 602.

A fine-tunable machine-learned agent 602 can be, comprise, be comprised by, or otherwise share one or more properties with a first machine-learned agent 102. For example, in some instances, a fine-tunable machine-learned agent 102 can have any property described above with respect to a first machine-learned agent 102, and vice versa.

Training input(s) 624 can generally include or otherwise represent various types of data. Training input(s) 624 can include one type or many different types of data. Training input(s) 624 can include data of the same type(s) or of different types of data as compared to second-agent data 104, input(s) 106, first-agent outputs 216, or second-agent outputs 220.

Example data types for training input(s) 624 can include text data (e.g., natural language text data, computer code text data), audio data, image data, video data, multimodal data (e.g., text and image, text and audio, etc.), binary data (e.g., binary computer code data, multimodal data communicated in a binary format, etc.), or other data type or combination of data types.

In some instances, training input(s) 624 can include sequence data indicative of all or part of one or more past interactions 522 of a second machine-learned agent 218. For example, in some instances, training inputs 624 can include input contexts that were provided to a second machine-learned agent 218 during past interactions 422. For example, in some instances, interaction data 522 can include or be indicative of a plurality of input-output pairs, with each input-output pair comprising a training input 624 that was provided to the second machine-learned agent 218 during an interaction 422 and a corresponding output (e.g., ground truth output) that was generated by the second machine-learned agent 218 based on the training input 624.

Pretrained layers 628 can include, for example, one or more layers of a first machine-learned agent 102. Pretrained layers 628 can include layers associated with various machine-learned model architectures, such as fully connected layers, attention layers, convolutional layers, recurrent layers, gated layers (e.g., long short-term memory layers, etc.), or other layer type. For example, in some instances, pretrained layers 628 can include every layer of a first machine-learned agent 102 that has not yet been fine-tuned. In some instances, a machine-learned agent 102, 602 can have pretrained layers of one type (e.g., fully connected) or many types. For example, in some instances, a machine-learned agent 102, 602 can have a plurality of fully connected layers; a plurality of attention layers or attention heads; and, optionally, one or more other layer types. In some instances, pretrained layers 628 can include layers that have been trained on a general-purpose or unsupervised training task, such as next token prediction, masked language modeling, or the like. In some instances, pretrained layers 628 can include layers that have not been fine-tuned for any specialized task other than a general-purpose pretraining task.

Second-agent adapter layer(s) 630 can include, for example, one or more machine-learned model layers (e.g., neural network layers, etc.) comprising a plurality of parameters (e.g., weights, etc.) per layer. In some instances, an adapter layer 630 can include a layer having an architecture that is the same as or different from one or more pretrained layers 628. For example, an adapter layer 630 can have a layer type (e.g., fully connected, attention, convolutional, etc.) that is the same as or different from one or more pretrained layers 628; a number of parameters that is the same as or different from (e.g., lower than, etc.) a number of parameters of one or more pretrained layers 628; a number of bits per parameter that is the same as or different from a number of bits per parameter of one or more pretrained layers 628; or other property that is the same as or different from a corresponding property of one or more pretrained layers 628. In some instances, one or more second-agent adapter layer(s) 630 can include one or more low-rank adaptation layers having a reduced dimensionality compared to a dimensionality of the pretrained layers 628. In some instances, an adapter layer 630 can include one or more rank decomposition matrices, such as a rank decomposition having a smaller number (e.g., greater than about ten times smaller, such as greater than about 100 times smaller, such as greater than about 1000 times smaller, such as greater than about 2000 times smaller, such as greater than about 5000 times smaller, such as greater than about 10000 times smaller, etc.) of trainable parameters compared to a total number of trainable parameters of the pretrained layers 628. In some instances, one or more adapter layers 630 (e.g., layers comprising rank decomposition matrices, etc.) can be configured to be placed between two or more pretrained layers 628. For example, in some instances, the adapter layers 630 can be interleaved with the pretrained layers 628 such that each pretrained layer 628 is associated with a corresponding adapter layer 630 (e.g., adapter layer 630 having a smaller number of trainable parameters compared to the pretrained layer 628, etc.).

Training outputs 632 can be, comprise, be comprised by, or otherwise share one or more properties with predicted second-agent outputs 108. For example, in some instances, training outputs 632 can have any property described above with respect to second-agent outputs 108, and vice versa. For example, training outputs 632 can be outputs generated by the fine-tunable machine-learned agent 602 based on corresponding training inputs 624.

Model updates 634 can include parameter update data (e.g., numerical parameter update values, etc.) for updating one or more parameters of the fine-tunable machine-learned agent 602. For example, in some instances, model updates 634 can include one or more numerical values for updating one or more parameters of the second-agent adapter layer(s) 630 of the fine-tunable machine-learned agent 602. In some instances, a numerical value for updating a parameter can include an adjustment value to be added to or subtracted from the corresponding parameters. Other values are possible (e.g., adjustment value to multiply or divide a parameter by, replacement parameter value to replace a prior parameter, etc.). In some instances, a data structure for storing or transmitting model updates 634 can include one or more tensors (e.g., matrices, vectors, etc.).

In some instances, determining a model update 634 can include evaluating an objective function. In some instances, an objective function can include a reward function or loss function, such as a reward or loss function comparing a training output 632 to a corresponding ground truth output. A ground truth output can include, for example, an output generated by the second machine-learned agent 218 (e.g., during an interaction 422) based on the same training input 624 used to generate the training output 632.

In some instances, determining a model update 634 can include backpropagation. For example, in some instances, a computing system 626 can evaluate a loss function based on a training output 632 and one or more ground truth outputs, and can generate a loss value associated with the training output 632. In some instances, the computing system 626 can determine one or more gradients of the loss function and can determine one or more model updates 634 based on the gradient(s). In some instances, a model update 634 can be scaled according to a learning rate parameter (e.g., by multiplying a gradient value by the learning rate parameter, etc.).

In some instances, a model update 634 can include updates to one or more parameters of the adapter layer(s) 630. In some instances, a model update 634 can lack any values for changing any parameter of the pretrained layers 628.

In some instances, second-agent adapter layers 630 can include adapter layers trained on data from just one machine-learned agent 218, 418 (e.g., a second machine-learned agent 218, etc.) or multiple machine-learned agents 218, 418. In some instances, to facilitate fine-tuning the second-agent adapter layers 630 based on multiple machine-learned models 218, 418, and to facilitate generating predicted second-agent outputs 108 based on each individual model of the multiple machine-learned agents 218, 418, the training inputs 624 can each include one or more delimiters indicative of a machine-learned agent 218, 418 associated with the respective training input. As a non-limiting illustrative example, the second-agent adapter layers 630 can be fine-tuned on interaction data 522 comprising data from both a second machine-learned agent 218 and a third machine-learned agent 418a. Continuing the example, each training input 624 can include one or more delimiters indicative of which machine-learned agent 218, 418a the training input 624 was provided to or indicative of one or more authors of a corresponding ground truth output, such as a delimiter indicating that the next tokens occurring after the delimiter will be tokens generated by the relevant machine-learned agent 218, 418a (e.g., “Agent 2:”, “Agent 3:”, etc.). In some instances, generating a predicted second-agent output 108 with a first machine-learned agent 102 that has been fine-tuned on data from multiple agents 218, 418 in this manner can include providing, to the first machine-learned agent 102, an input context comprising a delimiter associated with an appropriate agent 218, 418 (e.g., “Agent 2:”, “Agent 3:”, etc.). For example, in some instances, generating a predicted second-agent output 108 can include including, at the end of one or more input(s) 106, a delimiter indicating that the next tokens after the delimiter will be tokens associated with (e.g., generated by) a machine-learned agent 218, 418 to be imitated.

In some instances, a plurality of distinct adapters (e.g., with each adapter comprising one or more adapter layers) can be trained, with each adapter being fine-tuned on a distinct set of training data (e.g., training inputs 624, ground truth outputs, interaction data 522, etc.). For example, in some instances, each adapter can be fine-tuned based on interaction data 522 from a distinct machine-learned agent 218, 418 or distinct combination of machine-learned agents 218, 418. In this manner, for instance, a first machine-learned agent 102 can be trained to generate predicted second-agent outputs 108 for a plurality of different machine-learned agents 218, 418, with reduced memory footprint for storing updated model parameters compared to some alternative implementations (e.g., implementations storing N sets of pretrained layers 628 that have been fine-tuned without adapter layers, etc.). As another example, in some instances, a plurality of adapters can each be fine-tuned based on interaction data 522 associated with a particular task type of a plurality of task types; a particular input data type (e.g., text, image, audio, video, multimodal, etc.) of a plurality of data of input data types; a particular category of machine-learned agent (e.g., coder agent, math agent, physics agent, etc.); or other categorization.

In some instances, each distinct adapter can be trained according to any method described above with respect to second-agent adapter layers 630.

Although FIG. 6A depicts a fine-tunable machine-learned agent 602 having separate pretrained layers 628 and adapter layers 630, this is not required. For example, in some instances, a fine-tunable machine-learned agent 602 can lack adapter layers 630, and the pretrained layers 628 can be fine-tuned directly (e.g., according to any method described above with respect to fine-tuning one or more adapter layers 630).

FIG. 6B is a block diagram of an example system for storing fine-tuned parameters of a fine-tuned machine-learned agent according to example implementations of some aspects of the present disclosure. An adapter layer storage system 636 can store a plurality of adapters 638 each comprising one or more adapter layers. For example, in some instances, an adapter layer storage system 636 can store N adapters 638 associated with N distinct machine-learned agents 218, 418 of a multi-agent environment. Other implementations are possible (e.g., a single adapter; a plurality of adapters associated with a plurality of model families, model types, task types, etc.).

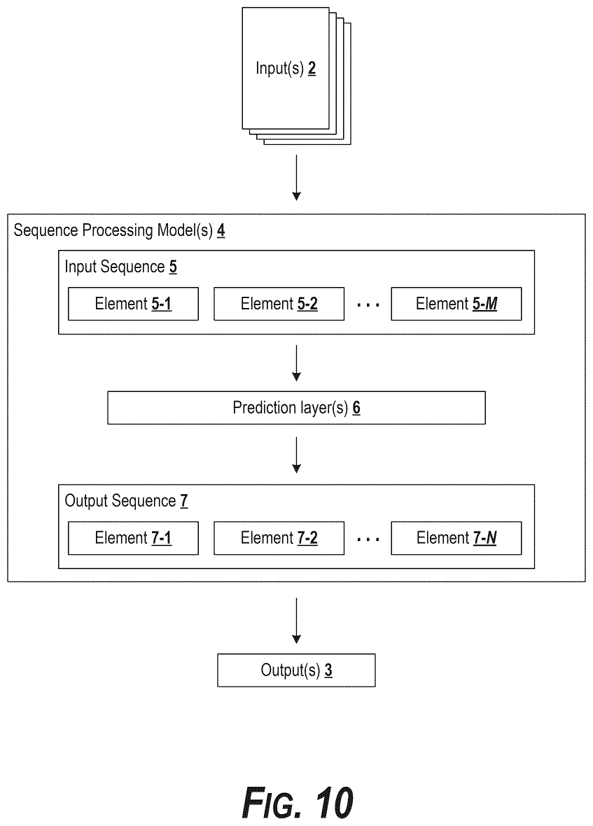

The adapter layer storage 636 can include, for example, one or more non-transitory computer-readable media (e.g., volatile memory device, non-volatile storage device, etc.) storing one or adapters 638. In some instances, the adapter layer storage 636 can include one or more devices or have one or more properties described below with respect to FIGS. 9-15, such as one or more properties of a memory 52, 62 of FIG. 15.

Adapter layer(s) 638 can be, comprise, be comprised by, or otherwise share one or more properties with second-agent adapter layer(s) 630. For example, second-agent adapter layer(s) 638a can be, comprise, or be comprised by second-agent adapter layer(s) 630 or can have any property described above with respect to adapter layer(s) 630. Similarly, third- or Nth-agent adapter layer(s) 638b, 638c can have any property described above with respect to second-agent adapter layer(s) 630, except that they can include layers that were trained based on interaction data 522 associated with a different machine-learned agent 418 compared to the second-agent adapter layer(s) 630.

Although FIG. 6B depicts a plurality of adapters 638 fine-tuned based on interaction data 522 from a plurality of distinct machine-learned agents 218, 418, other implementations are possible. For example, in some instances, a plurality of adapters 638 can be fine-tuned on interaction data 522 subsets associated with a plurality of task types; data types; clusters; machine-learned embedding regions; or other categorization.

### Example Methods

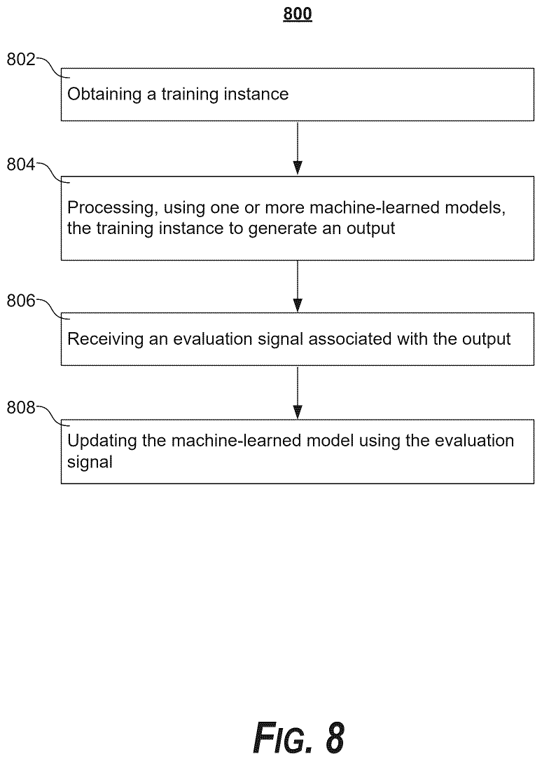

FIG. 7 depicts a flowchart diagram of an example method for agent emulation in a multi-agent environment according to example embodiments of the present disclosure. Although FIG. 7 depicts steps performed in a particular order for purposes of illustration and discussion, the methods of the present disclosure are not limited to the particularly illustrated order or arrangement. The various steps of example method 700 can be omitted, rearranged, combined, and/or adapted in various ways without deviating from the scope of the present disclosure.

At 702, example method 700 can include obtaining, by a computing system (e.g., computing system 626) comprising one or more computing devices, first data (e.g., second-agent data 104, interaction data 522, etc.) indicative of one or more outputs of one or more second machine-learned models (e.g., machine-learned agents 218, 418, etc.). In some instances, example method 700 at 702 can include using one or more systems or performing one or more activities described with respect to FIGS. 1-5.

At 704, example method 700 can include providing, by the computing system to a first machine-learned model (e.g., machine-learned agent 102, 602, etc.), the first data. In some instances, example method 700 at 704 can include using one or more systems or performing one or more activities described with respect to FIGS. 1-6B.

At 706, example method 700 can include providing, by the computing system to the first machine-learned model, a first input context (e.g., input(s) 106, etc.). In some instances, example method 700 at 706 can include using one or more systems or performing one or more activities described with respect to FIGS. 1-4.

At 708, example method 700 can include generating, by the computing system using the first machine-learned model, one or more predicted outputs (e.g., predicted second-agent outputs 108, etc.) of the one or more second machine-learned models based at least in part on the first input context. In some instances, example method 700 at 708 can include using one or more systems or performing one or more activities described with respect to FIGS. 1, 2B, or 3.

At 710, example method 700 can include selecting, by the first machine-learned model based at least in part on the one or more predicted outputs, one or more selected actions (e.g., action selections 110, etc.) from an action space. In some instances, example method 700 at 710 can include using one or more systems or performing one or more activities described with respect to FIGS. 1-4.

At 712, example method 700 can include causing, by the computing system, the one or more selected actions to be performed (e.g., using one or more tools 111, etc.). In some instances, example method 700 at 712 can include using one or more systems or performing one or more activities described with respect to FIGS. 1-4.

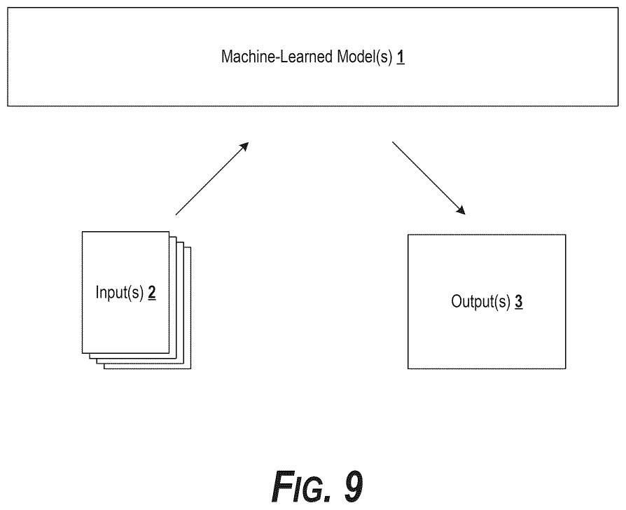

FIG. 8 depicts a flowchart of a method 800 for training one or more machine-learned models according to aspects of the present disclosure. For instance, an example machine-learned model can include a machine-learned agent 102, 218, 418, 602.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types. In some implementations, example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Routing Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), chemical or biochemical data, image data, audio data, audiovisual data, haptic data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and astronomical data, sensor data and chemical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

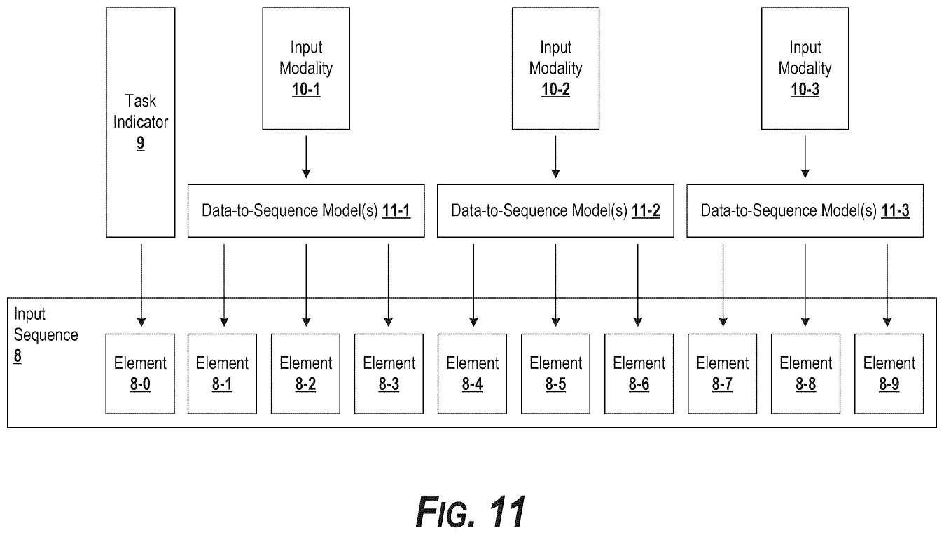

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2,. 5-M, etc. obtained from input(s) 2. Sequence processing model 4 can process input sequence 5 using prediction layer(s) 6 to generate an output sequence 7. Output sequence 7 can include one or more output elements 7-1, 7-2,. 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition Scale Scale, ARXIV:2010.11929v2 (Jun. 3, 2021), audio domains, e.g. e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All Need Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

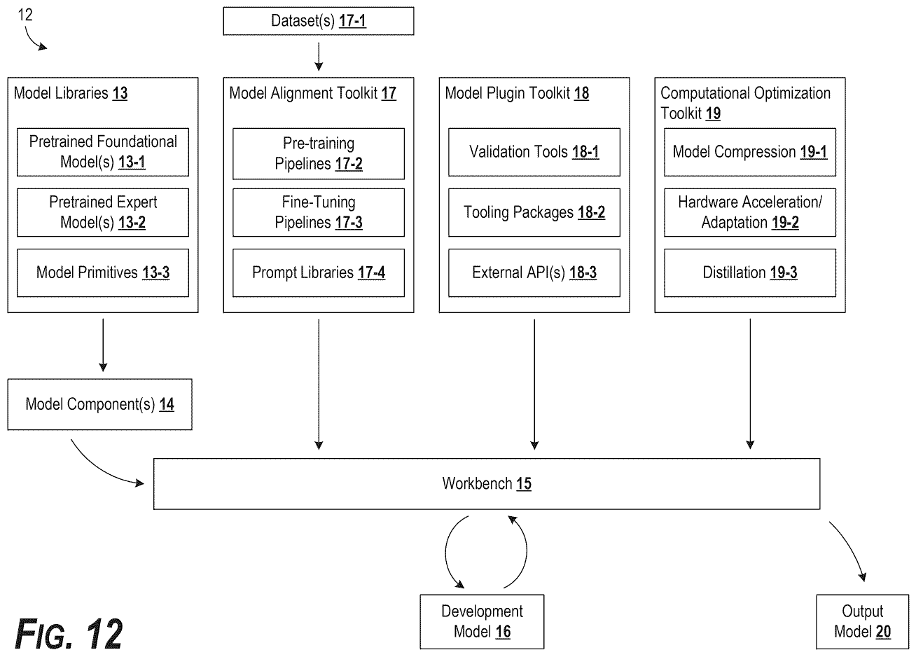

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

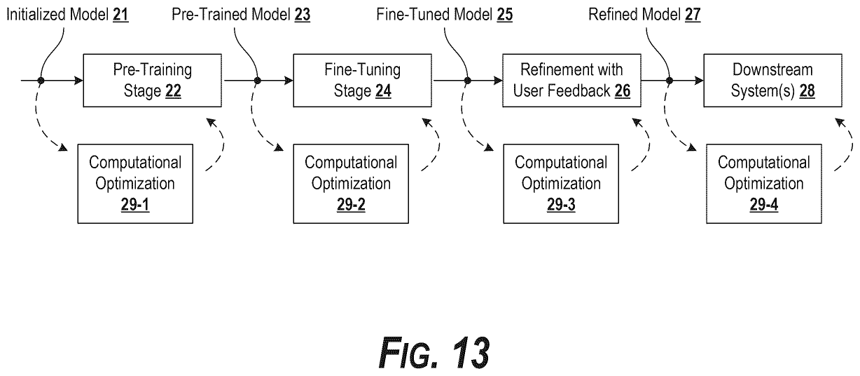

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

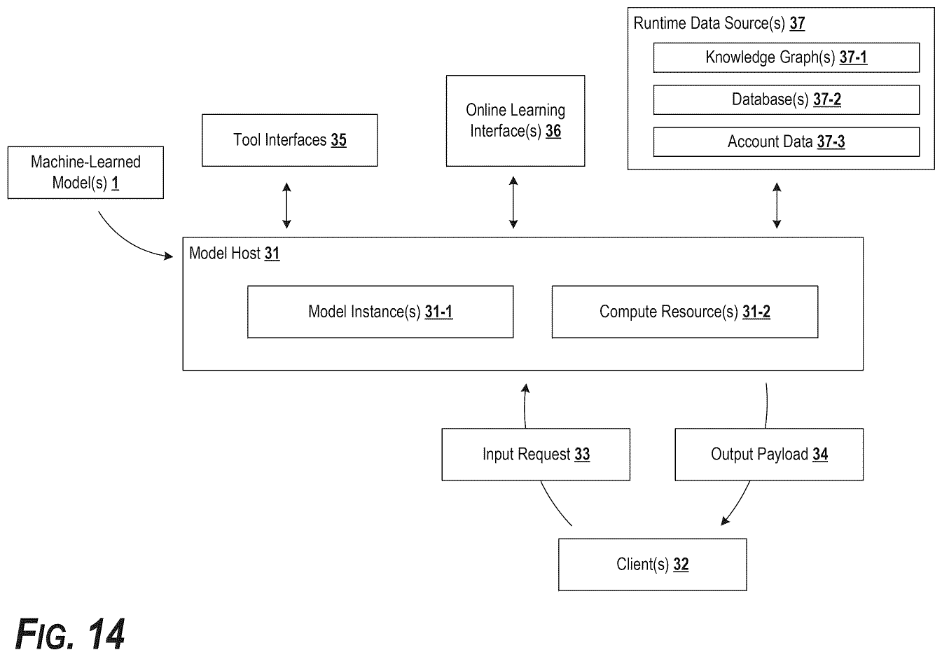

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

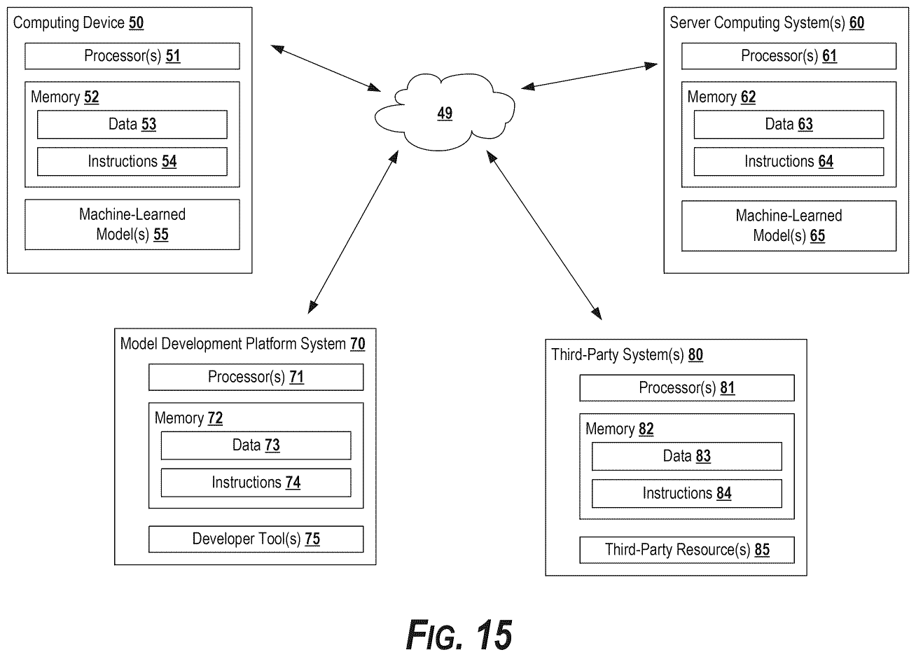

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

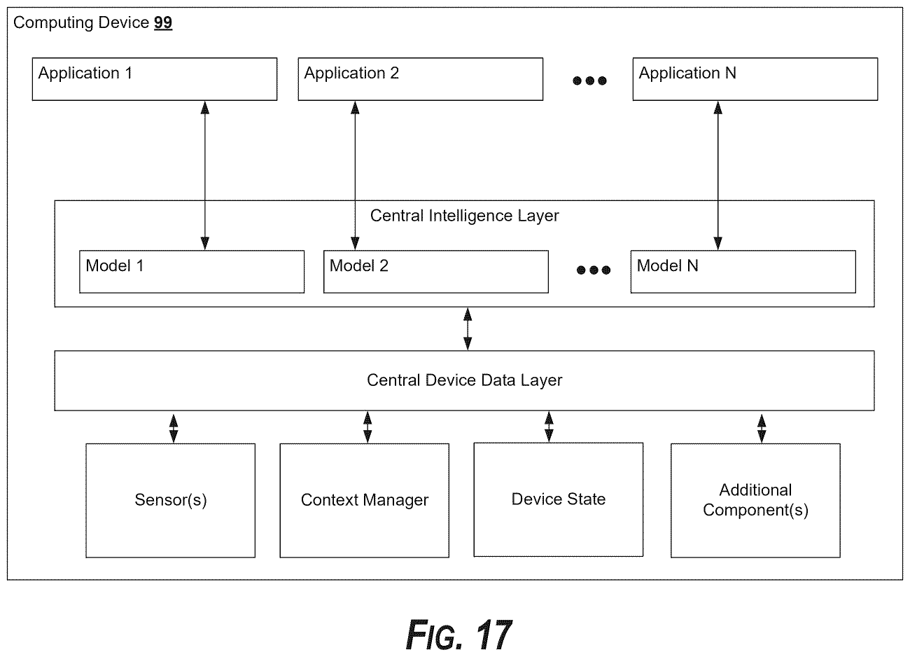

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 17 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method, comprising:
obtaining, by a computing system comprising one or more computing devices, first data indicative of one or more outputs of one or more second machine-learned models;
providing, by the computing system to a first machine-learned model, the first data indicative of the one or more outputs of the one or more second machine-learned models;
providing, by the computing system to the first machine-learned model, a first input context;
generating, by the computing system using the first machine-learned model, one or more predicted outputs of the one or more second machine-learned models based at least in part on the first input context;
selecting, by the first machine-learned model based at least in part on the one or more predicted outputs, one or more selected actions from an action space; and
causing, by the computing system, the one or more selected actions to be performed.

2. The method of claim 1, wherein causing the one or more selected actions to be performed comprises:
mapping, by the computing system, an action selection output of the first machine-learned model to a corresponding application programming interface (API) call; and
calling, by the computing system, a first API according to the corresponding API call.

3. The method of claim 1, wherein providing the first data comprises including the first data in the first input context.

4. The method of claim 1, wherein:
the first data is parameter update data;
obtaining the parameter update data comprises:
obtaining, by the computing system, training data indicative of one or more interactions of the one or more second machine-learned models, the training data comprising a plurality of input-output pairs, each input-output pair comprising a second input context provided to the one or more second machine-learned models during the one or more interactions and a corresponding second-model output generated by the one or more second machine-learned models during the one or more interactions;
providing, by the computing system to the first machine-learned model, one or more second input contexts of the plurality of input-output pairs;
receiving, by the computing system from the first machine-learned model, one or more training outputs based on the one or more second input contexts; and
determining, by the computing system based on a loss function comparing the one or more training outputs to one or more corresponding second-model outputs, the parameter update data; and
providing the parameter update data comprises updating, by the computing system, one or more parameters of the first machine-learned model according to the parameter update data.

5. The method of claim 4, wherein the first machine-learned model comprises one or more adapter layers, and wherein updating the one or more parameters comprises updating the one or more adapter layers.

6. The method of claim 5, wherein:
the computing system comprises a plurality of adapters associated with the first machine-learned model, wherein each adapter of the plurality of adapters comprises one or more adapter layers for predicting outputs of a corresponding second or third machine-learned model; and
further comprising:
selecting, by the computing system from the plurality of adapters, a first adapter associated with the one or more second machine-learned models; and
including, by the computing system, the first adapter in the first machine-learned model;
wherein the one or more predicted outputs are generated using the first adapter.

7. The method of claim 1, wherein the first data comprises one or more first delimiters identifying one or more authors of the one or more outputs, and the first input context comprises at least one second delimiter identifying at least one second machine-learned model of the one or more second machine-learned models as an author of the one or more predicted outputs.

8. The method of claim 1, further comprising:
receiving, by the computing system from the first machine-learned model, one or more confidence values associated with the one or more predicted outputs; and
determining, by the computing system based at least in part on the one or more confidence values, whether to generate, using the one or more second machine-learned models, one or more true outputs based on the first input context.

9. The method of claim 1, further comprising:
obtaining, by the computing system, second data indicative of at least one of:
an availability of the one or more second machine-learned models;
a cost of using the one or more second machine-learned models; and
one or more data access permissions associated with the first input context and the one or more second machine-learned models; and
determining, by the computing system based at least in part on the second data, whether to generate, using the one or more second machine-learned models, one or more true outputs based on the first input context.

10. The method of claim 9, wherein the one or more second machine-learned models comprise a plurality of second machine-learned models, and further comprising:
selecting, by the computing system from the plurality of second machine-learned models, a selected machine-learned model to generate the one or more true outputs; and
generating, by the computing system using the selected machine-learned model, the one or more true outputs.

11. The method of claim 10, wherein selecting is based at least in part on one or more of:
one or more respective amounts of interaction data available for one or more respective second machine-learned models of the plurality of second machine-learned models; and
success level data indicative of one or more respective levels of success associated with one or more respective second machine-learned models of the plurality of second machine-learned models.

12. The method of claim 11, wherein the success level data comprises task-specific success level data for a plurality of task categories.

13. The method of claim 1, wherein the first machine-learned model has a number of parameters that is smaller than a number of parameters of at least one second machine-learned model of the one or more second machine-learned models, and further comprising:
providing, by the computing system to the at least one second machine-learned model, data indicative of the one or more predicted outputs; and
receiving, by the computing system from the at least one second machine-learned model, one or more true outputs generated based at least in part on the one or more predicted outputs.

14. The method of claim 13, wherein the one or more predicted outputs comprise a plurality of tokens, and further comprising:
evaluating, in parallel, by a plurality of processors of the computing system using the at least one second machine-learned model, the plurality of tokens to generate a plurality of token probabilities; and
editing, by the computing system based on the plurality of token probabilities, the one or more predicted outputs to generate the one or more true outputs.

15. The method of claim 13, wherein generating the one or more predicted outputs comprises:
generating, by the first machine-learned model based at least in part on the first input context, a plurality of draft tokens;
evaluating, by the first machine-learned model, the plurality of draft tokens to generate a plurality of token probabilities, each token probability indicative of a respective probability that the at least one second machine-learned model would output a respective draft token of the plurality of draft tokens; and
editing, by the computing system based on the plurality of token probabilities, the plurality of draft tokens to generate the one or more predicted outputs.

16. The method of claim 1, wherein obtaining the first data comprises:
retrieving, by the computing system based at least in part on the first input context or a second input context, the first data.

17. The method of claim 1, further comprising:
generating, by the computing system using the first machine-learned model, a first output based at least in part on the first input context;
wherein the one or more predicted outputs are generated based at least in part on the first output.

18. The method of claim 1, further comprising:
providing, by the computing system to the first machine-learned model, data indicative of one or more results of the one or more selected actions; and
receiving, by the computing system from the first machine-learned model, an output based on the data indicative of the one or more results.

19. A computing system comprising one or more processors and one or more non-transitory computer-readable media storing instructions that are executable by one or more processors to cause the computing system to perform operations, the operations comprising:
obtaining first data indicative of one or more outputs of one or more second machine-learned models;
providing, to a first machine-learned model, the first data indicative of the one or more outputs of the one or more second machine-learned models;
providing, to the first machine-learned model, a first input context;
generating, using the first machine-learned model, one or more predicted outputs of the one or more second machine-learned models based at least in part on the first input context;
selecting, by the first machine-learned model based at least in part on the one or more predicted outputs, one or more selected actions from an action space; and
causing the one or more selected actions to be performed.

20. One or more non-transitory computer-readable media storing instructions that are executable by one or more processors to cause a computing system to perform operations, the operations comprising:
obtaining first data indicative of one or more outputs of one or more second machine-learned models;
providing, to a first machine-learned model, the first data indicative of the one or more outputs of the one or more second machine-learned models;
providing, to the first machine-learned model, a first input context;
generating, using the first machine-learned model, one or more predicted outputs of the one or more second machine-learned models based at least in part on the first input context;
selecting, by the first machine-learned model based at least in part on the one or more predicted outputs, one or more selected actions from an action space; and
causing the one or more selected actions to be performed.
